(19) United States
(12) Patent Application Publication
(10) Pub. No.: US 2017/0323390 A1
(43) Pub. Date: Nov. 9, 2017

(54) INSURANCE WORKFLOW MANAGEMENT SERVER, SYSTEM AND METHOD

(71) Applicant: WholeSource, LLC, Phoenix, AZ (US)

(72) Inventors: James Keating, Phoenix, AZ (US); Mark Meury, Phoenix, AZ (US); Donald Fleming, Phoenix, AZ (US)

(21) Appl. No.: 15/596,358

(22) Filed: May 16, 2017

Related U.S. Application Data
(63) Continuation-in-part of application No. 14/970,860, filed on Dec. 16, 2015.
(60) Provisional application No. 62/095,424, filed on Dec. 22, 2014.

(51) Int. Cl. G06Q 40/08; G06F 3/0481; G06F 3/0484; G06F 3/0486

(52) U.S. Cl. CPC G06Q 40/08; G06F 3/0486; G06F 3/04817; G06F 3/04842

(57) ABSTRACT

Some embodiments of the invention include a workflow management system including a server, a user terminal configurable as a geographically distributed computing network in network communication with the server. The server is configured to execute the software instructions to automatically direct a user through an insurance account binding process by communicating with the server using the user terminal. The system is configured to execute the software instructions to automatically generate a document library that includes a folder structure associated with a particular account. An automated email server can email the account to at least one insurance market or underwriter based at least in part on user preference. Further, the software application can provide for a drag and drop feature where a user selecting, dragging and dropping an icon representing an electronic file, and automatically saving the file in a named folder corresponding to the electronic file.

### BACKGROUND

The management of certain service accounts (such as, for example, accounts involving the purchase and ownership of various types of insurance) currently involves the use of multiple, distinct software applications. When managing accounts, a user must typically access a plurality of these various software applications. These software applications often do not communicate with each other, and do not provide for a centralized remote access to an account management system utilizing the multiple, distinct software applications. Rather, to manage and properly document an account from creation (beginning the policy opening process) through binding (completion of the policy opening process), a user must access several applications separately on a user computer and manually going through several steps to utilize the various multiple and distinct applications. What is lacking is a system that can easily and efficiently accomplish all aspects of account processing and management.

Accordingly, there is a need for an improved management system that allows for complete workflow management and electronic document storage without the need to access multiple, distinct software programs separately from multiple user interfaces.

### SUMMARY

Some embodiments of the invention include an insurance workflow management system comprising a server having a processor, memory, and a non-transitory computer-readable medium in data communication with the processor. Some embodiments of the system further comprise a user terminal configurable as a geographically distributed computing network in network communication with the server, where the user terminal comprises a virtual/personal computer having a processor, memory, a hard disk, a video card, a display, and input/output devices. In some embodiments, the workflow management system comprises a software application installed on the non-transitory computer-readable medium and operated by the server. In some embodiments, the software application includes software instructions comprising the workflow management system, and the server is configured to execute the software instructions to automatically direct a user through an insurance account binding process by communicating with the server using the user terminal. In some embodiments, the system is configured to execute the software instructions to automatically generate a document library stored on at least one of the hard drive of the server and remote data storage, the document library including a folder structure associated with a particular account. In some embodiments, the folder structure is automatically created by the server in response to the server executing the software instructions based on user input and a life cycle of the account, the life cycle comprising account initiation and clearance, and management from clearance through one or more intermediary steps and to invoicing the account. Further, in some embodiments, the system comprises or is linked to an automated email server, the automated email server configured to email the account to at least one insurance market or underwriter based at least in part on user preference. Further, in some embodiments, the software application operating on the server is configured and arranged to provide for a drag and drop feature, where the drag and drop feature comprises a user selecting, dragging and dropping an icon representing an electronic file, and automatically saving the file in a named folder corresponding to the electronic file.

In some embodiments, the server executes the software instructions based on user input and enables the user to perform a drag and drop action from one portion of the GUI to another portion of the GUI to initiate the life cycle of the account. In some embodiments, the server executing the software instructions based on user input is configured to enable the user to drag an account submission received into the email server from an insurance agency and displayed on a GUI of the display to at least another portion of the GUI to access a component of the life cycle or generate an update to the life cycle. In some embodiments, the account submission comprises a submission from an agency for an insured looking for a specific piece of insurance coverage. In some embodiments, each named folder of the workflow management system is associated with a particular step required to process and manage an account.

Some embodiments further comprise an automatic email save function, where emails sent through the system are automatically saved in a folder of the folder structure of the electronic library in response to executed code of the software application by the server. In some embodiments, the server is configured and arranged to automatically create a copy of the dragged electronic file for the user to redact in response to dragging the electronic document and dropping it in an active window displayed on the user terminal.

In some embodiments, the life cycle comprises steps to process one or more accounts, the steps comprising application sections including at least one of clearance, submit to market, quote to agent, bind and invoice, endorsements, accounting, and claims. In some embodiments, the steps comprise a specific sequence of steps of clearance, followed by submit to market, followed by quote to agent, followed by bind and invoice, followed by endorsements, followed by accounting, and followed by claims.

In some embodiments, the software application operating on the server is configured and arranged to provide for a user to access or enter specific information for one or more accounts including at least one of loss information history and claim information for a specific submission, enter underwriting information, one or more carriers information, premium and deductibles, and quote information.

In some embodiments, the software application operating on the server is configured and arranged to provide for a user to generate taxes on an account and use rating tools to underwrite an account. In some further embodiments, the server executing the software instructions based on user input is configured to enable the user to drag into the GUI claim adjuster information sent from a carrier assigned to an insurance claim. In some other embodiments, the server executing the software instructions based on user input is configured to enable the user to send insurance adjusters information to an agent.

In some embodiments, the software application includes executable code to enable the server to display a dashboard including widgets to show in real-time or substantially real-time at least one of retail agencies revenues, carriers premiums, month to date results, year to date results, producer monthly projections, marketing calendar, pipeline, overdue receivables and suspense, and account reconciliation.

Some embodiments include a workflow management system comprising a server having a processor, memory, and a non-transitory computer-readable medium in data communication with the processor, and a user terminal configurable as a geographically distributed computing network in network communication with the server. In some embodiments, the user terminal comprises a virtual/personal computer having a processor, memory, a hard disk, a video card, a display, and input/output devices; and a software application installed on the non-transitory computer-readable medium and operated by the server. In some embodiments, the software application include software instructions comprising the workflow management system where the server is configured to execute the software instructions to automatically direct a user through an insurance account binding process by communicating with the server using the user terminal. In some embodiments, the software application is configured and arranged to provide for a drag and drop feature comprising a user selecting, dragging and dropping an icon representing an electronic file, and automatically saving the file in a named folder corresponding to the electronic file. In some embodiments, the folder structure is automatically created by the server in response to the server executing the software instructions based on user input in one or more steps of a life cycle of the account. In some embodiments, the steps comprise application sections including at least one of clearance, submit to market, quote to agent, bind and invoice, endorsements, accounting, and claims.

In some embodiments, the system comprises or is linked to an automated email server, the automated email server configured to email the account to at least one insurance market or underwriter based at least in part on user preference. In some embodiments, each named folder of the workflow management system is associated with a particular step required to process and manage an account. In some embodiments, the life cycle comprises account initiation and clearance, and management from clearance through one or more intermediary steps and to invoicing the account.

In some embodiments, the system further comprises an automatic email save function, where emails sent through the system are automatically saved in a folder of the folder structure of the electronic library in response to executed code of the software application by the computing device. In some other embodiments, software application operating on the server is configured and arranged to create a copy of the dragged electronic document for the user to redact in response to dragging the electronic document and dropping it in an active window. In some further embodiments, the software application operating on the server is configured and arranged to create a copy of the dragged electronic document for the user to redact in response to dragging the electronic document and dropping it in an active window of the GUI.

### DESCRIPTION OF THE DRAWINGS

FIG. 1 is a view of a dashboard screen in accordance with some embodiments of the invention;

FIGS. 2A-2C are views of various navigation screens in accordance with some embodiments of the invention;

FIG. 3 is a view of a clearance screen in accordance with some embodiments of the invention;

FIG. 3A illustrates a folder tree structure in accordance with some embodiments of the invention;

FIG. 4 is a view of a clearance screen with a decline account option in accordance with some embodiments of the invention;

FIG. 5 is a view of an account search screen in accordance with some embodiments of the invention;

FIG. 6 is a view of a clearance screen in accordance with some embodiments of the invention;

FIG. 7 is a view of a submission screen after a user has dragged a submission into the system screen in accordance with some embodiments of the invention.

FIG. 8 is a view of a cover letter screen form in accordance with some embodiments of the invention;

FIG. 9 is a view of a screen for the user to choose which markets and underwriters to send the submission in accordance with some embodiments of the invention;

FIG. 10 is a view of a screen summarizing the submitted submission in accordance with some embodiments of the invention;

FIG. 11 is a view of a quote screen in accordance with some embodiments of the invention;

FIG. 12 is a view of a quote entry form screen in accordance with some embodiments of the invention;

FIG. 13 is a view of a quote summary screen in accordance with some embodiments of the invention;

FIG. 14 is a view of a bind and invoice screen in accordance with some embodiments of the invention;

FIG. 15 is a view of a bind and invoice screen after a user drags in a binder from the carrier in accordance with some embodiments of the invention;

FIGS. 16A-16B are a views of a bind and invoice entry form in accordance with some embodiments of the invention;

FIG. 17 is a view of binder summary screen in accordance with some embodiments of the invention;

FIG. 18 is a view of policy screen in accordance with some embodiments of the invention;

FIGS. 19A-19B are views of a policy data entry form in accordance with some embodiments of the invention;

FIG. 20 is a view of an endorsement screen in accordance with some embodiments of the invention;

FIG. 21 is a view of save agent endorsement request screen generated when dragging in an endorsement request into the endorsement screen of FIG. 20 in accordance with some embodiments of the invention;

FIG. 22 is a view of a send endorsement screen in accordance with some embodiments of the invention;

FIG. 23 is a view of a save carrier endorsement screen in accordance with some embodiments of the invention;

FIG. 24 is a view of a send carrier endorsement screen in accordance with some embodiments of the invention.

FIG. 25 is a view of an accounting screen in accordance with some embodiments of the invention.

FIG. 26 is a view of a production dashboard screen in accordance with some embodiments of the invention.

FIGS. 27A-27B are views of a producer dashboard screen in accordance with some embodiments of the invention.

FIGS. 28A-28B are views of a team leader dashboard screen in accordance with some embodiments of the invention.

FIGS. 29A-29B are views of an executive dashboard screen in accordance with some embodiments of the invention.

FIG. 30 is a view of a workers compensation submission screen with detail on marketing an account in accordance with some embodiments of the invention.

FIG. 31 is a view of a workers compensation loss information screen in accordance with some embodiments of the invention.

FIG. 32 is a view of a workers compensation underwriting information screen.

FIG. 33 is a view of a rate screen for use with small business underwriting in accordance with some embodiments of the invention.

FIG. 34 is a view of a save agent/create submission screen in accordance with some embodiments of the invention.

FIG. 35 is a view of a submitted summary screen in accordance with some embodiments of the invention.

FIG. 36 is a view of a claims screen in accordance with some embodiments of the invention.

FIG. 37 is a view of a claim request screen in accordance with some embodiments of the invention.

FIG. 38 is a view of a send claim screen in accordance with some embodiments of the invention.

FIG. 39 is a view of an assignment screen in accordance with some embodiments of the invention.

FIG. 40 is a view of a marketing calendar screen in accordance with some embodiments of the invention.

FIG. 41 is a view of add marketing appointment screen in accordance with some embodiments of the invention.

FIG. 42 illustrates a computer system of the workflow management system in accordance with some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

As discussed above, some embodiments of the invention relate to a workflow management system that manages all aspects of a customer account (including, for example, new account setup and maintenance, electronic account document storage, and invoicing) through one user interface. For new accounts, the user interface walks the user through the account binding process from initial information gathering (clearance, in the case of an insurance policy) to invoicing. For existing accounts, the user interface walks the user through all account management functions.

Various components are required for the workflow management system to operate. In some embodiments, the system is accessed through a remote desktop management session. In some embodiments, the workflow management system includes a server having a processor, memory, a hard drive, and a network card. In some embodiments, the system also includes a user terminal, where the user terminal is a dummy terminal. In some embodiments, a dummy terminal includes a computing device having a processor, memory, a hard disk, a video card, a display, a network card, and input/output devices, such as but not limited to, a keyboard, a mouse and the like. In some embodiments, the dummy terminal does not store any critical data; rather it is used to access the server through a user portal. In some embodiments, the server operates to perform all of the operations of the workflow management system, stores all of the data associated with various accounts, performs complex operations related to the various accounts, and executes software and operating systems of the workflow management system. In some embodiments, the user terminal operates to display workflow management system information and account information on the display of the user terminal, and to provide information to the server for processing. In some embodiments, the processor and memory of the user terminal operate to process the information necessary to provide the user interface to the display, to for access the information on the server, and perform other tasks of the workflow management system. In some embodiments, the input/output devices operate to allow user input to the user terminal, and to allow output of the workflow management system to be provided to the user via the user terminal. In some embodiments, user input provided to the user terminal is sent through a network connection between the user terminal and the server to the server for processing of that user input data by the server. In some embodiments, the user interface is configured to display data and programs running on the server.

Some embodiments employ a user terminal that is a dummy terminal that can provide an extra layer of security for the workflow management system. Because the user terminal only accesses account information stored and maintained on the server (rather than locally on the user terminal), if the user terminal is damaged, stolen or otherwise compromised, the account information is not at risk because the information is not stored locally on the user terminal.

In operation, in some embodiments, the user terminal provides for a user interface having various components that allow the input of information to the server, and display server information on the user terminal. In some embodiments, the input and information is communicated to and from the server through a network connection between the server and the user terminal. In some embodiments, the user interface is separated into various sections and/or screens that can be displayed individually or simultaneously in sections of the display of the user terminal. In some embodiments, the various sections and/or screens can include, without limitation, dashboards, navigation screens, clearance screens, multiple screens, split-screens, extended desktop screens, and other screens. Although specific reference is can be made throughout this application to terms related to the insurance industry, it should be appreciated that the workflow management system can be utilized in a variety of fields and applications other than insurance.

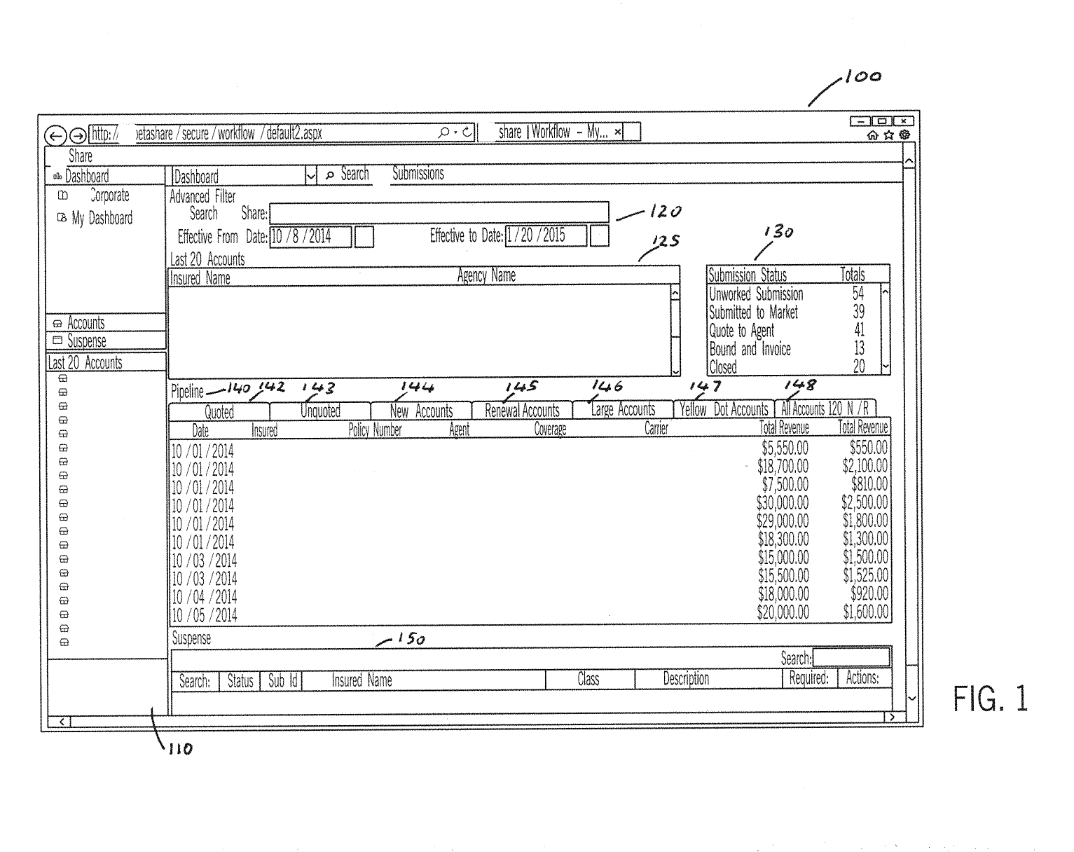

Some embodiments of the invention include a producer dashboard 100, as shown in FIG. 1 that can provide a user the ability to manage client accounts (such as, in the case of insurance, a book of business). The user can be a “producer” (also known as an insurance agent in the case of an insurance application) and his associates (other members of the company working for or with an assigned user). In some embodiments, when a user accesses the workflow management system, the user view can default to the user (producer, in the case of insurance), or in the case of an associate of the user (producer), the user (producer) to which they are assigned. In some embodiments, at the producer dashboard, a user can change producers or search for an account. In some embodiments, in response to execution of software instructions on the server, the dashboard can be displayed on a graphical user interface (hereinafter “GUI”), for example such as a GUI of a user terminal display (e.g., such as an active terminal display or a so-called “dumb” terminal display). In some embodiments, the dashboard can be accessed at the user terminal by logging into the system through a web portal or the like. Once logged in, the display can display graphical information being processed by the server and sent to the display of the user terminal.

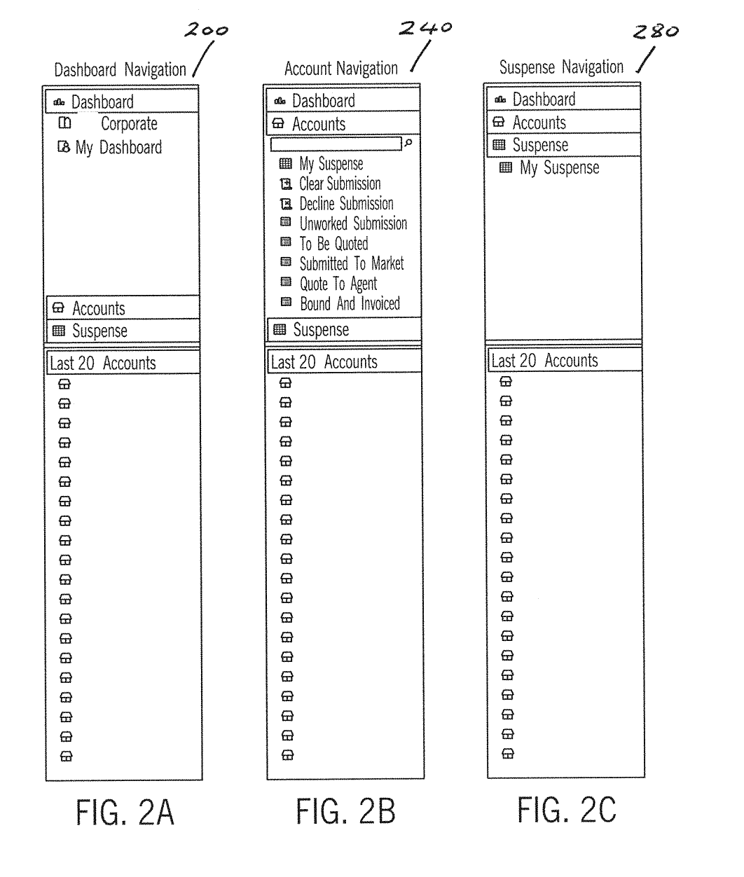

In some embodiments of the invention, pages displayed to a user of the workflow management system on a user terminal can include a identically formatted navigation panel 110 on one side of the display (e.g., such as the left-hand side of the display of the user terminal). In some embodiments, the functions of the navigation panel can be accessed at any time via any displayed page of the workflow management system. In some embodiments, the navigation panel can be located on the left of the display and is fixed (in terms of location, format and functions available) for all pages or screens of the workflow management system. In some embodiments, the navigation panel can allow the user to efficiently navigate to and through various accounts, or to search for an account. Some example embodiments of the navigation panel 110 are generally illustrated in FIGS. 2A-2C, in which FIG. 2A generally illustrates the navigation panel 200 when “Dashboard” is selected by the user, FIG. 2B generally illustrates the navigation panel 240 when “Accounts” is selected by the user, and FIG. 2C generally illustrates the navigation panel 280 when “Suspense” is selected by the user. Any one of the panels 200, 240, 280 can be selected or deselected as the navigation panel 110 of the producer dashboard 100 shown in FIG. 1.

In some embodiments, the producer dashboard 100 can be used to perform a variety of functions including a searching for submissions (e.g., using the search field 120), displaying a list of accounts using the account window 125, reviewing the status of submissions (e.g., using the submission window 130), and/or reviewing account pipelines (e.g., using the pipeline window 140). In some embodiments, the pipeline window 140 can comprise various information tabs including, but not limited to, a quoted tab 142, unquoted tab 143, new accounts tab 144, renewal accounts tab 145, large accounts tab 146, yellow dot accounts 147, and an all accounts tab 148. In some embodiments, suspense accounts and other suspense items can be searched and/or viewed in the suspense window 150.

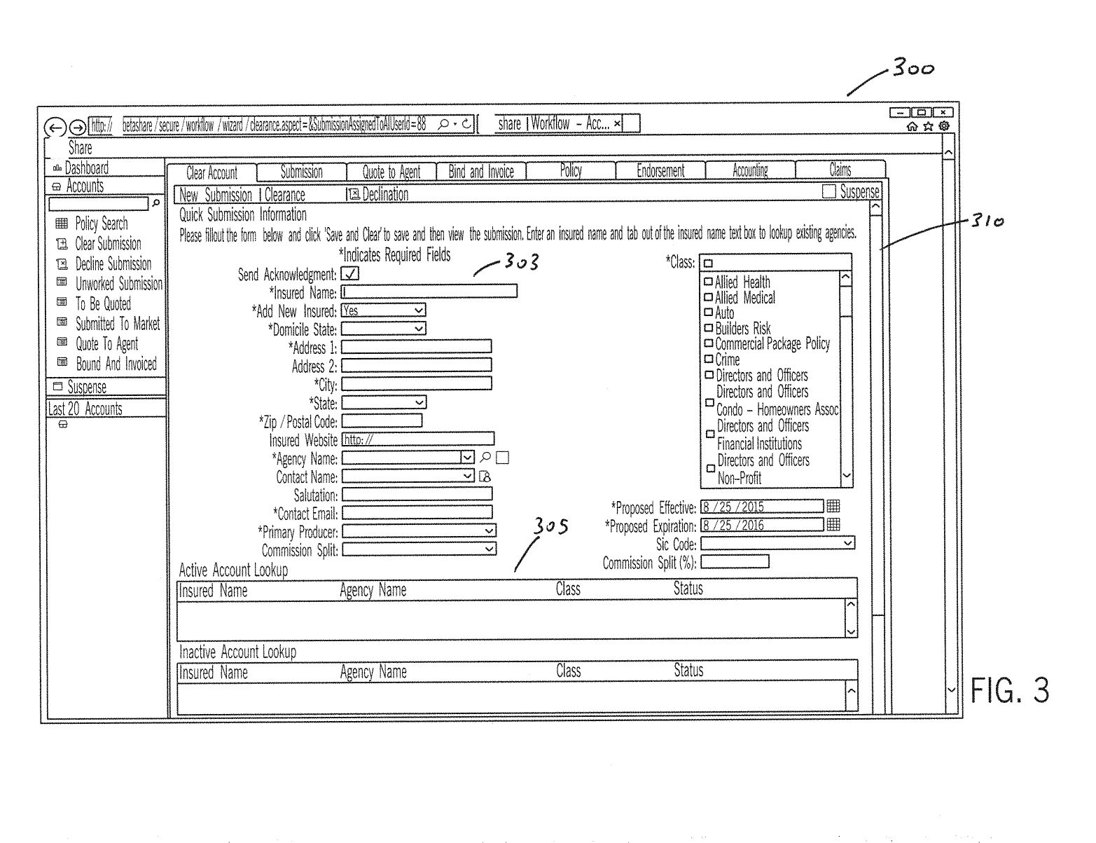

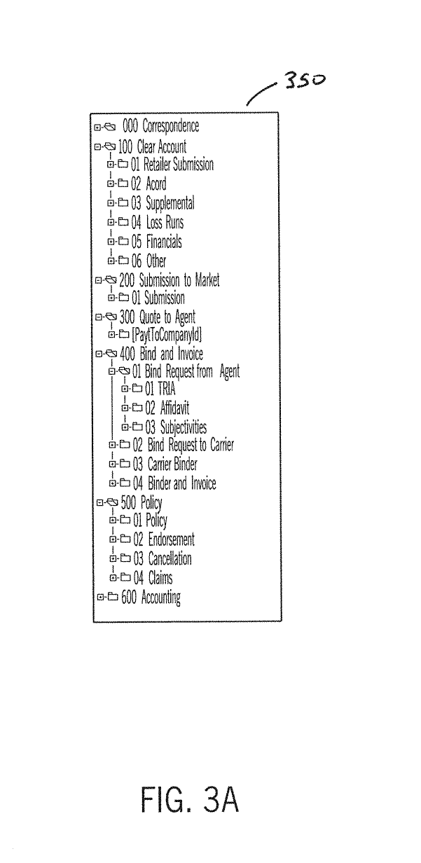

Some embodiments include a clearance screen 300, for example, as shown in FIG. 3, that can allow a user to enter a new account in the workflow management system. In some embodiments, a new account is a submission from an agency (e.g., such as an insurance agency) for an insured individual or entity looking for a specific type of insurance coverage. In some embodiments, a new submission form 303 of the submission window 310 can be used to look up existing agencies. In some embodiments, when a user enters an insured individual or entity name into search fields 305 of the submission window 310, the workflow management system can automatically search for all similar named insured individuals or entities in the system as stored in the hard drive of the server. This can allow the user to avoid entering redundant information already in the system if the insured individual or entity already exists in the workflow management system.

In some embodiments of the invention, once the new account is created (either by entering the new insured information, or using already stored information), a unique or specific folder structure can be automatically created in an electronic document library of the workflow management system. In some embodiments, the folder structure can be associated with that particular insured's account, and can allow one or more look-ups in the future of the insured's information in the database of the hard drive of the server. In some embodiments, the folder structure of the library can be maintained on remote data storage, such as a cloud service, digital media and the like. In some embodiments, the server or computing device operating the software application can be in communication with the remote data storage in order to obtain and process the information. In some embodiments, the folder structure can enable storing and organization of the account documents, communications (such as, for example, emails) and the like associated with that particular insured's account. In some embodiments, once an account is created, an automated email is generated to the insurance agency for that particular policy and account, and the email is saved in the electronic document library for the insured's account.

According to some embodiments of the invention, the unique or specific folder structure created by the system in the electronic document library for a particular insured's account can represent the life cycle of the account. For example, in some embodiments, the life cycle of the account can comprise account initiation and clearance, and management from clearance through one or more intermediary steps to invoicing the account. In some embodiments, the naming convention and organization of the folders can be standardized. In some embodiments, each main folder can correspond to the specific application section the user is working on in the system. In some embodiments, the sub-folders within the application folders can represent and correspond with the steps and contains all the necessary correspondence and files associated with that particular section/phase of the life cycle of the account. In some embodiments, the system can start with “000 Correspondence” and work its way up to “600 Accounting.” In some embodiments, application level folders can be incremented by 100. In some embodiments, sub-folders start with 01 and can work up 02, 03, etc. For example, some embodiments of the workflow management system include a folder tree structure 350 as shown in FIG. 3A.

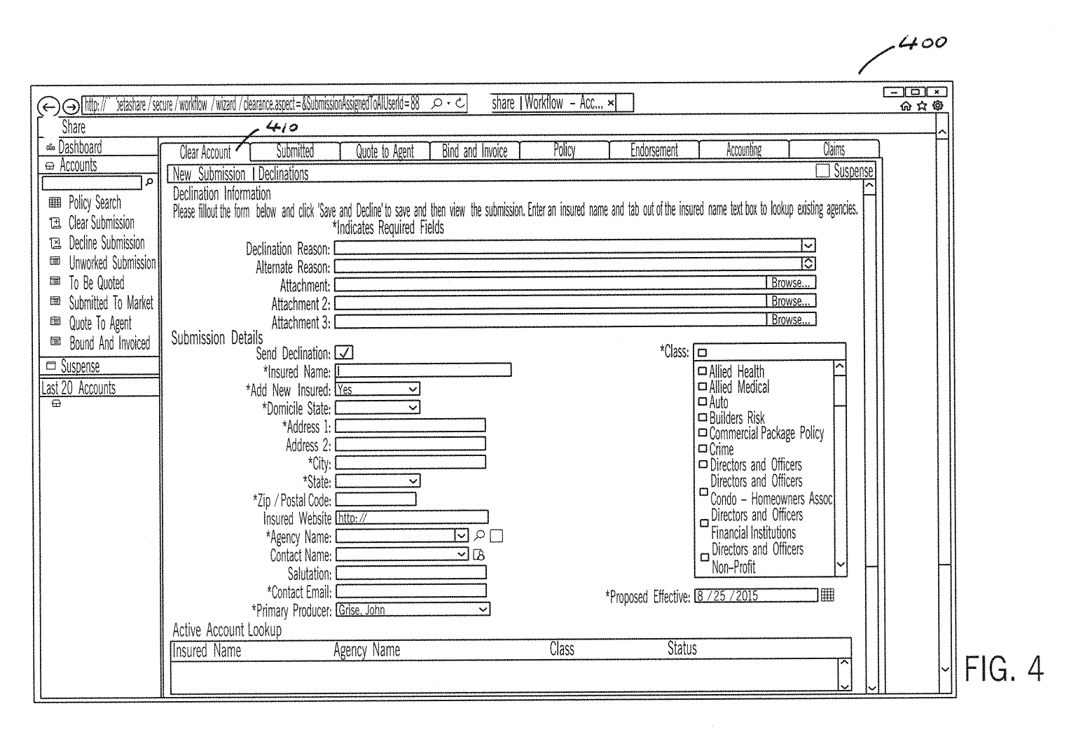

In some embodiments, the decline screen 400 shown in FIG. 4 under the “Clear Account” tab 410 can be used to enable a user to decline an account in the system. In some embodiments, the user can also flag (“Yellow Dot”) the account, such that the system can automatically notify the user to review the account in a certain number of days (e.g., such as 120 days) prior to it renewing. In one non-limiting example embodiments, this procedure can be followed if the user wants to market to the client the following year. In some embodiments, a unique folder structure can be automatically created in the electronic document library capturing the information associated with the declining of an account. In some embodiments, an automated email can be generated to the agency and saved in the electronic document library for the account.

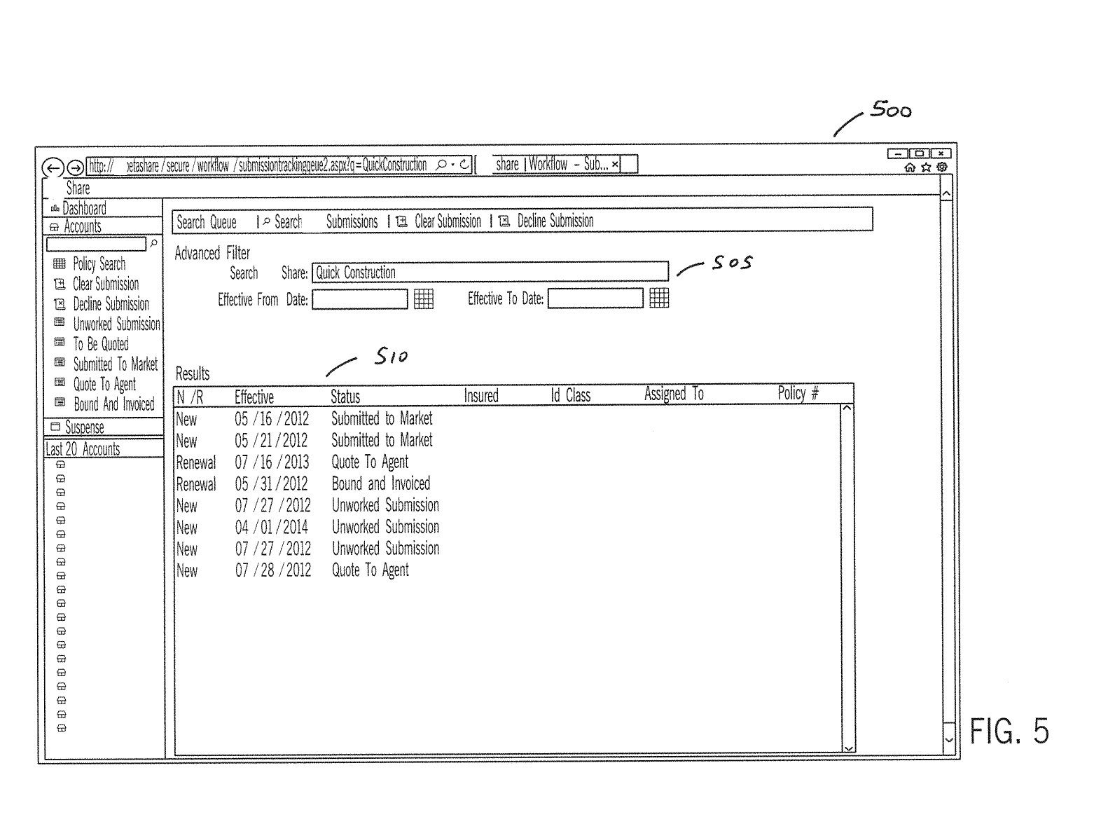

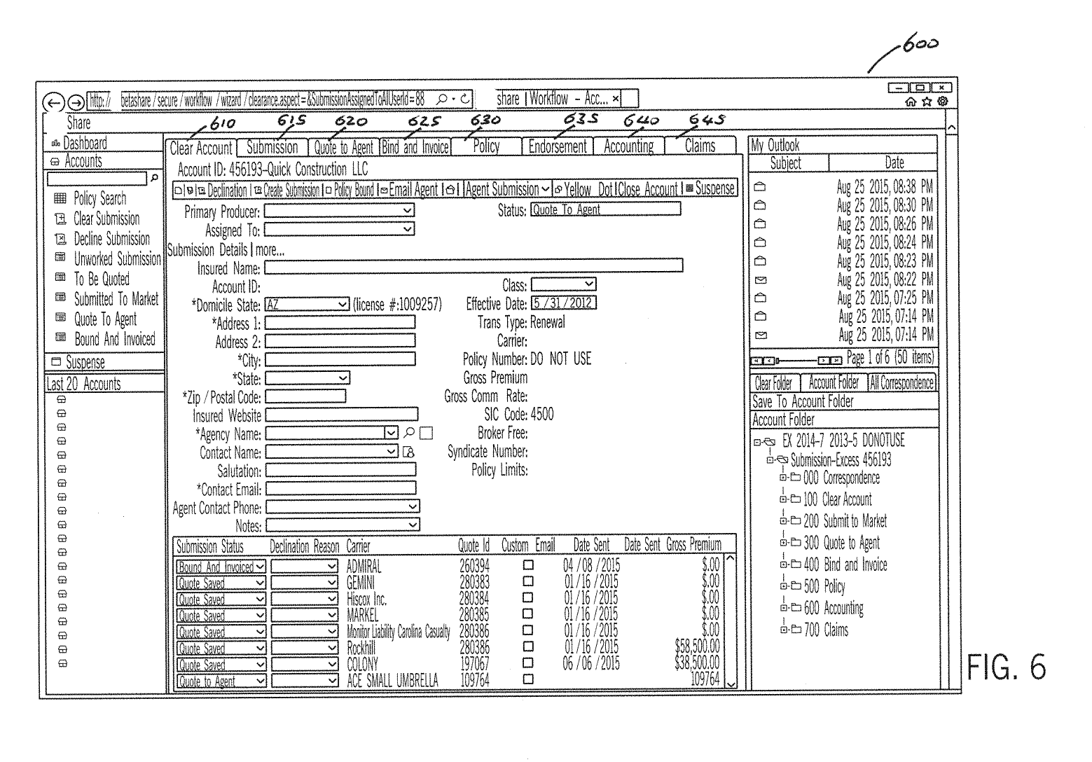

In some embodiments, the user can search for a specific insured in the workflow management system using the account search screen 500 shown in FIG. 5. In some embodiments, the workflow management system can use fuzzy logic to look up and list relevant accounts specific to a search term entered in the search field 505. Any accounts from the search can be listed in the results window 510. Those of ordinary skill in the art can understand that while fuzzy logic can be used for search purposes, other types of search strategies and algorithms can be employed by the workflow management system, such as Boolean searching and the like. In some embodiments, clicking on an account can navigate the user to an account workflow screen, and take them to the step where the account has been left in the life cycle of the account.

In some embodiments, the account workflow is a screen showing and allowing access to the various applications used or required to process and manage an account during the life-cycle of an account and/or policy. Some embodiments include a clearance screen. For example, FIG. 6 shows a clearance screen 600 comprising a basic screen to show the details of the account. In some embodiments, the applications (shown as tabs in FIG. 6) include: Clearance (“Clear Account”) (tab 610), which is active and shows the account information and status of submissions of quotes, Submit To Market (“Submitted”) (tab 615), Quote To Agent (“Quoted”) (tab 620), Bound and Invoice (“Bind and Invoice”) (tab 625), (“Policy”) (tab 630), Endorsements (“Endorsement”) (tab 635), Accounting (“Accounting”) (tab 640), and Claims (“Claims”) (tab 645). In some embodiments, the application can be tailored specifically to various profit centers and/or divisions of the business utilizing the workflow management system. In some embodiments, each application section has task tabs to walk the user through the tasks associated with each application. In some embodiments, if a task is not completed in the sequence of applications (left-to-right), the user is prevented from proceeding to the next task. Further, in some embodiments, the last application tab can always be a summary tab to allow the user to not have to navigate back to previous tabs to retrieve information. In some embodiments, as a user completes the application sections, the tabs associated with those completed application sections can show the text in black. In some embodiments, all white text in a tab indicates an application task which has not been completed. In other embodiments, the section and/or tab text can be other colors, shades of color, and/or patterned or textured, animated, or a combination thereof.

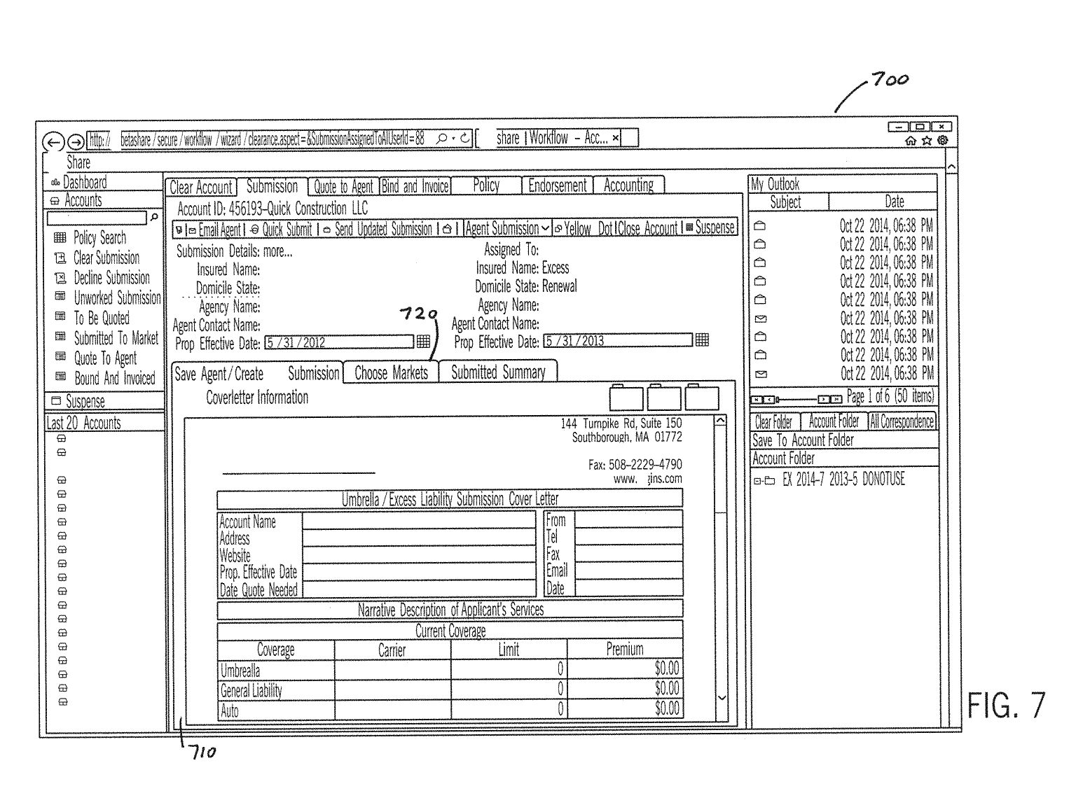

In some embodiments, as is generally illustrated screen 700 of FIG. 7, a user can drag a submission into the workflow management system screen from an email or other portion of the workflow management system. For example, in some embodiments, a user can couple to a display or screen (or gesture to the display or screen), and drag and drop an icon or other graphical element from one portion of the GUI to another portion of the GUI. In some embodiments, this user action can initiate a life cycle of the account.

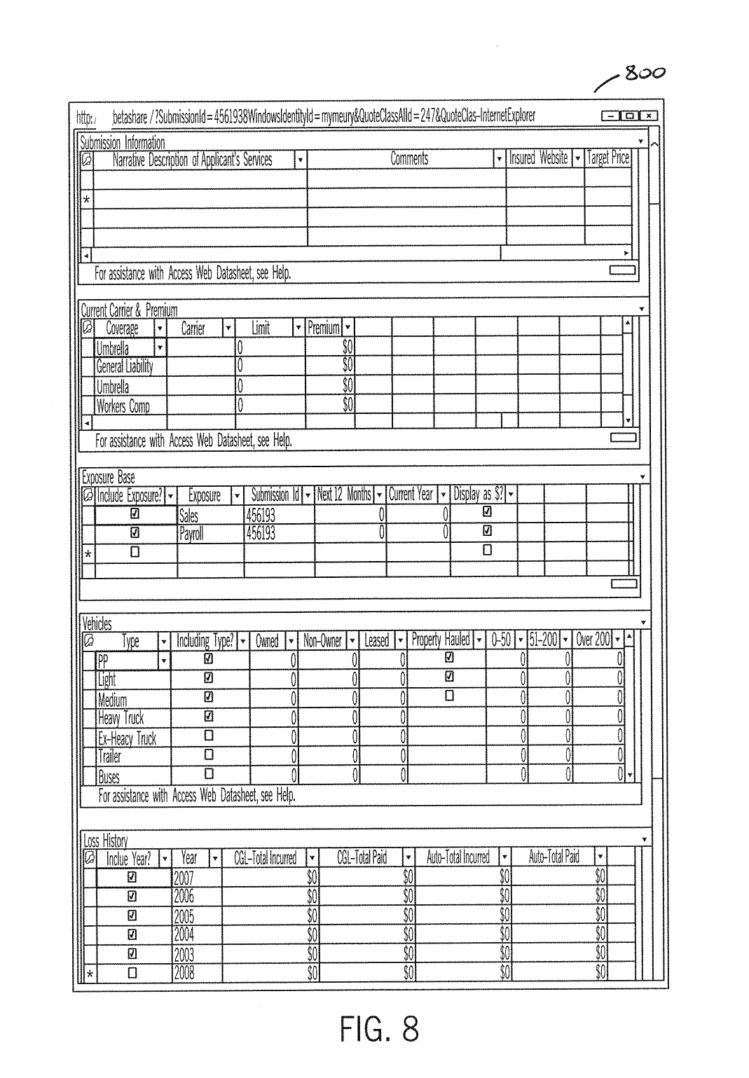

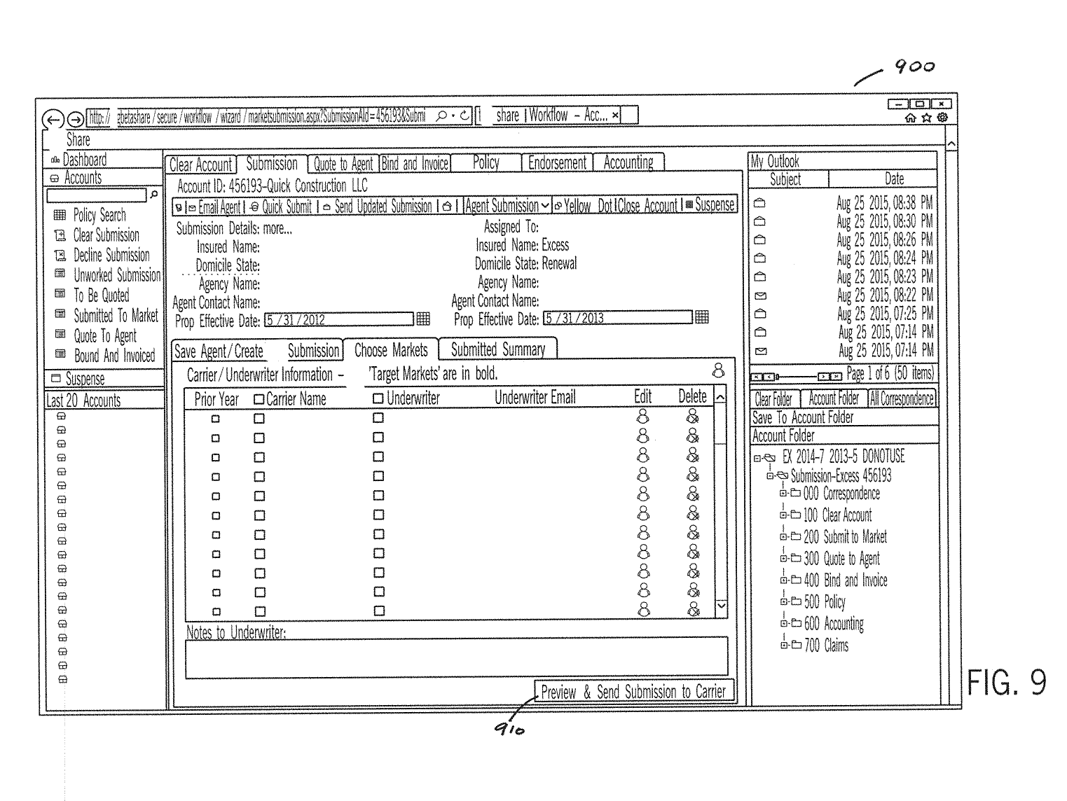

In some embodiments, an account submission can be received over the interne and displayed in a portion of the GUI (e.g., such as an email server portion), and a user can drag a folder representing the account submission into an account or submission tab or window on the GUI. In some embodiments, once the submission is dragged and dropped in the workflow management system screen, the system can automatically save the original email and attachments in a designated folder of the folder structure of the electronic document library associated with the relevant account. In addition, the system can make a copy of the dragged document for the user to redact. In some embodiments, clicking on the “create submission folder” (shown in FIG. 6) can cause the workflow management system to display the submission for the user to redact (shown in screen 700 of FIG. 7), and further, can cause a cover letter entry form having all required field for the defined class of business to be generated. In some embodiments, the workflow management system can open the submission on the left side of the screen in a PDF viewer, and can open the cover letter entry form on the right side of the screen. A cover letter entry form is generally illustrated displayed in screen 800 in FIG. 8. In some embodiments, a preview of the cover letter can be seen when the user clicks on the first tab on the left of the “Submission” screen (the “Save Agent/Create Submission” tab 710 in FIG. 7).

In some embodiments, an email of the submission to a third party via the system's automated email system can be initiated by a user. For example, as is generally illustrated in screen 900 of FIG. 9, showing one example embodiment of what is displayed when the “Choose Markets” tab 720 is selected by a user (see FIG. 7), a user can choose which market(s) and underwriters to email the submission to via the system's automated email system. In some embodiments, if a submission has not been added to the system already, the “Preview & Send Submission to Carrier” button 910 may not appear. In some embodiments, if the button 910 does appear, clicking the button 910 can display a form, which can allow the user to select uploaded attachments and preview and send the submission. In some embodiments, all correspondence generated is saved in their respected carrier folder in the electronic document library.

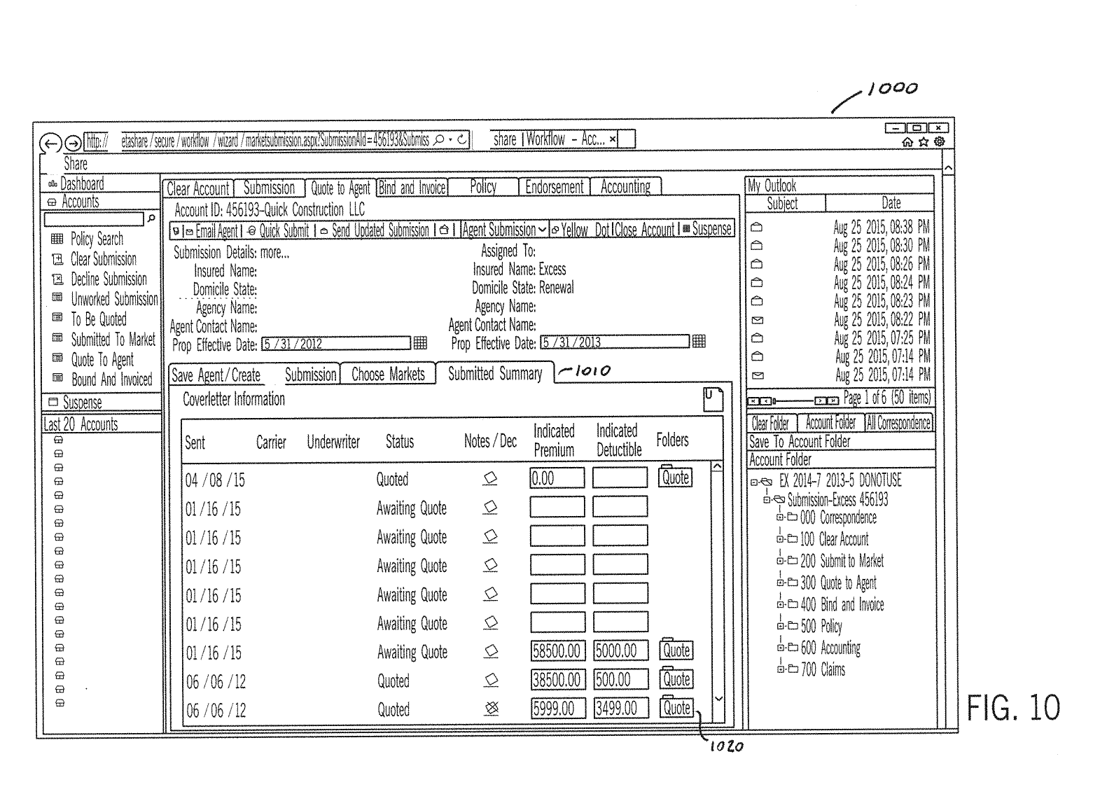

FIG. 10 generally illustrates the “Submitted Summary” page 1000 of the “Submission Screen.” In some embodiments, this screen allows a user to preview a list of carriers to whom submissions have been provided (submitted summary tab 1010). In addition, in some embodiments, this screen provides the opportunity for users to add indicated premium and deductibles to the record. Finally, in some embodiments, if a quote has already been saved, a quote folder 1020 can display. Clicking on the folder can open the saved quote.

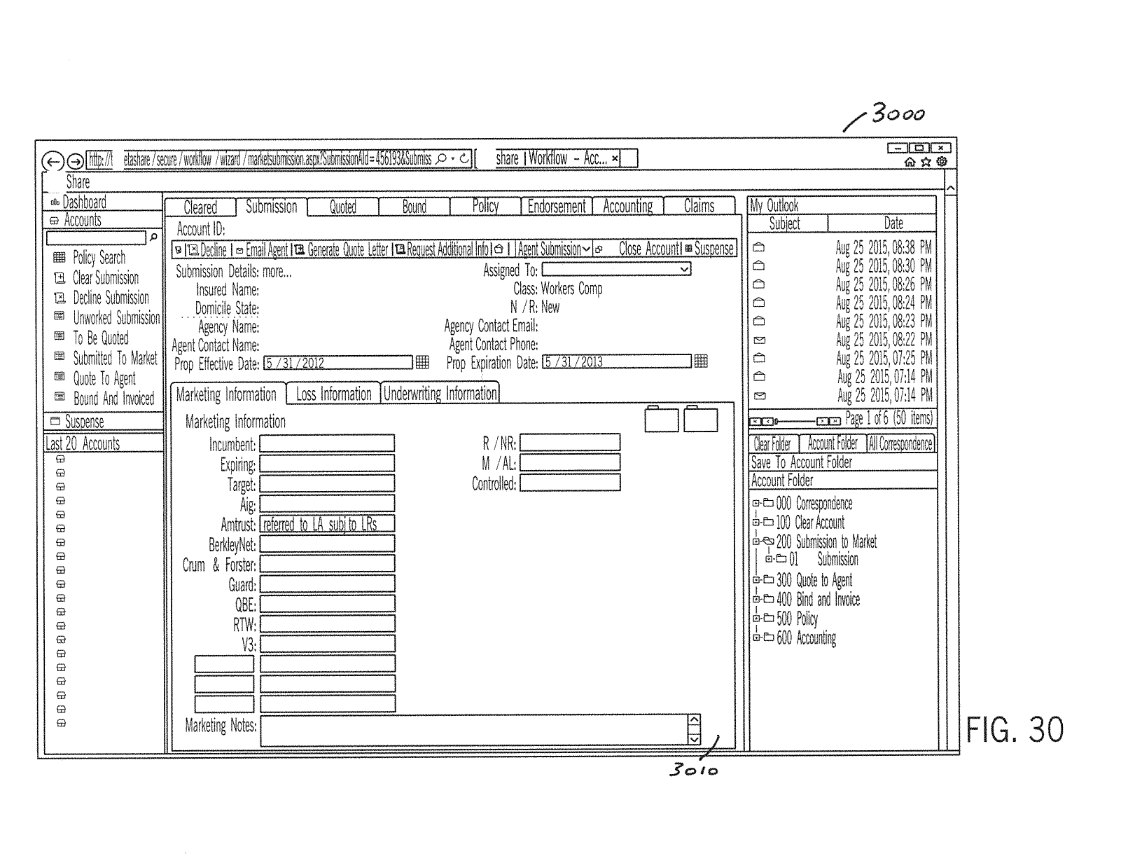

In some embodiments, the submission screen can be a basic screen to show the details on marketing an account. As shown in the screen 3000 of FIG. 30, in some embodiments, a user can drag a submission into the system. In some embodiments, once the submission is in the system, the system can save the original email and attachments, and additionally can make a copy of the document for the end-user to redact the “Marketing Information” (from tab 3010).

In some embodiments, clicking on the create submission folder can operate to have the system display the submission for a user to redact and a cover letter entry form of all required field for the defined class of business. In some embodiments, the system can open the submission in PDF editing software and the cover letter form, similar to that shown in FIG. 7.

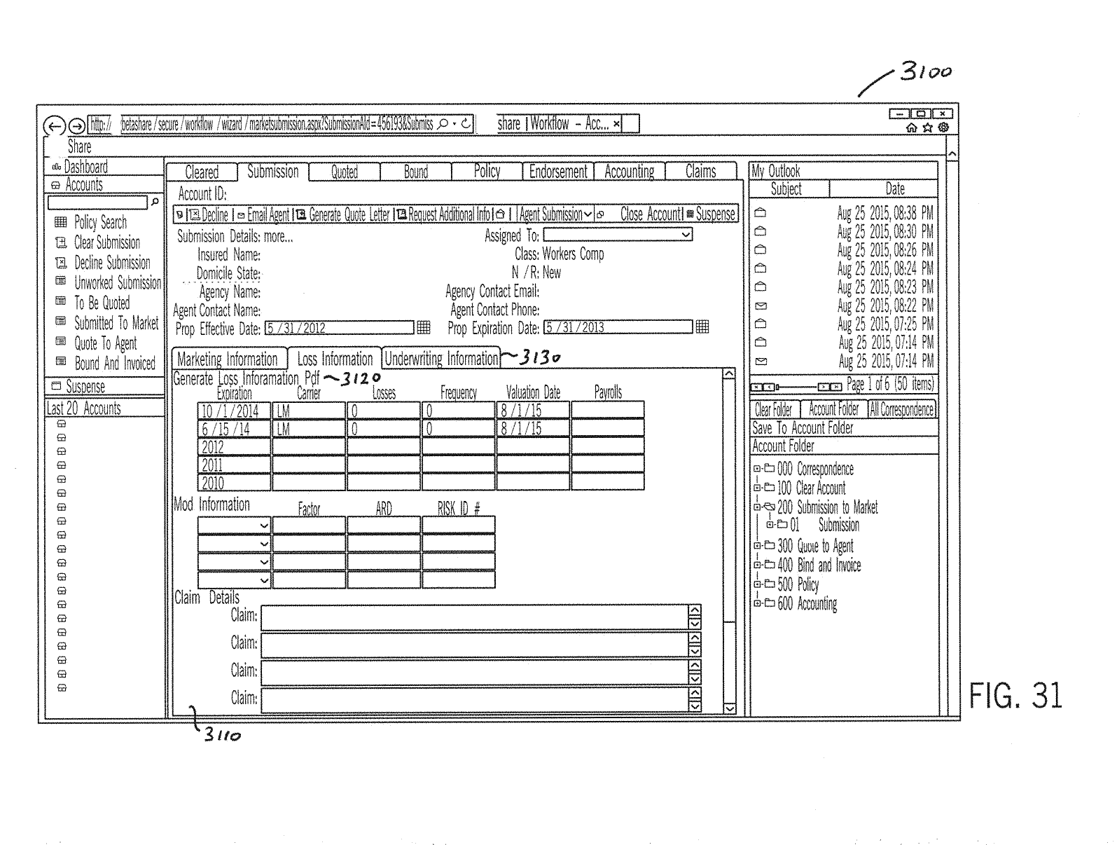

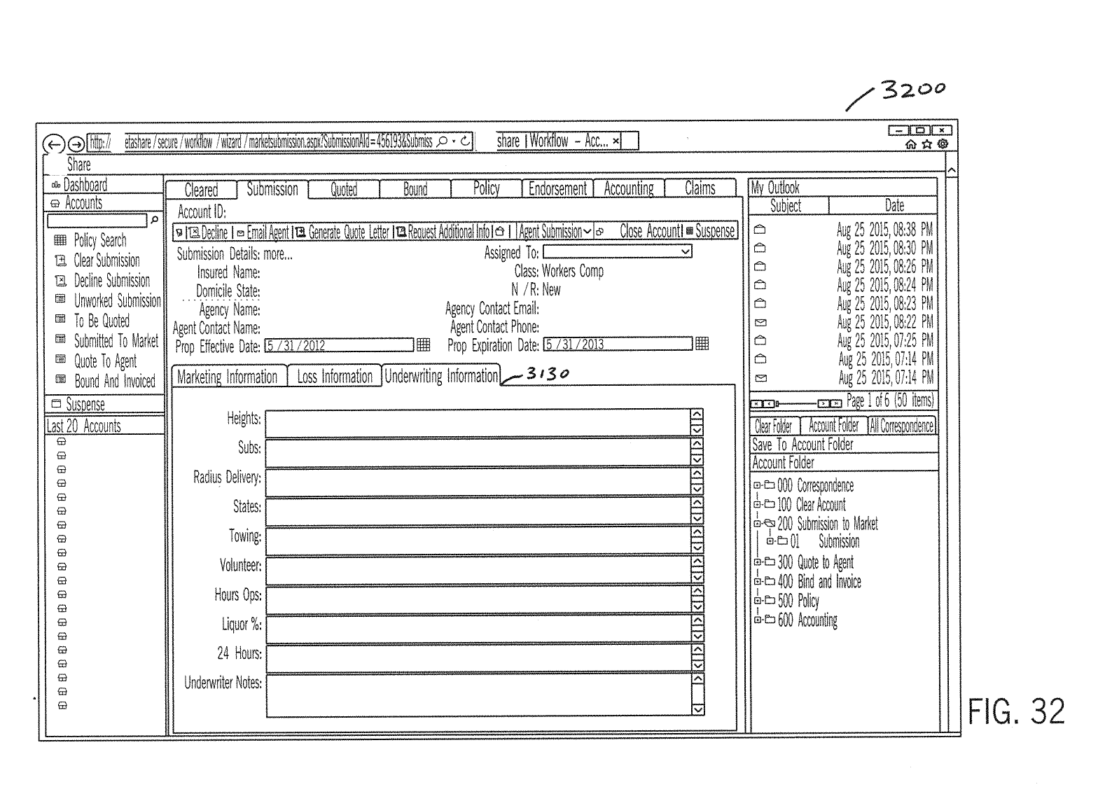

Referring to screen 3100 of FIG. 31, in some embodiments, a user can enter loss information history and claim information for a specific submission (e.g., within one or more fields of tab 3110). In some embodiments, clicking on “Generate Loss Information Pdf” header 3120 can generate a formatted pdf report on the loss history. Further, as shown in the screen 3200 of FIG. 32, a user can enter underwriting information using tab 3130.

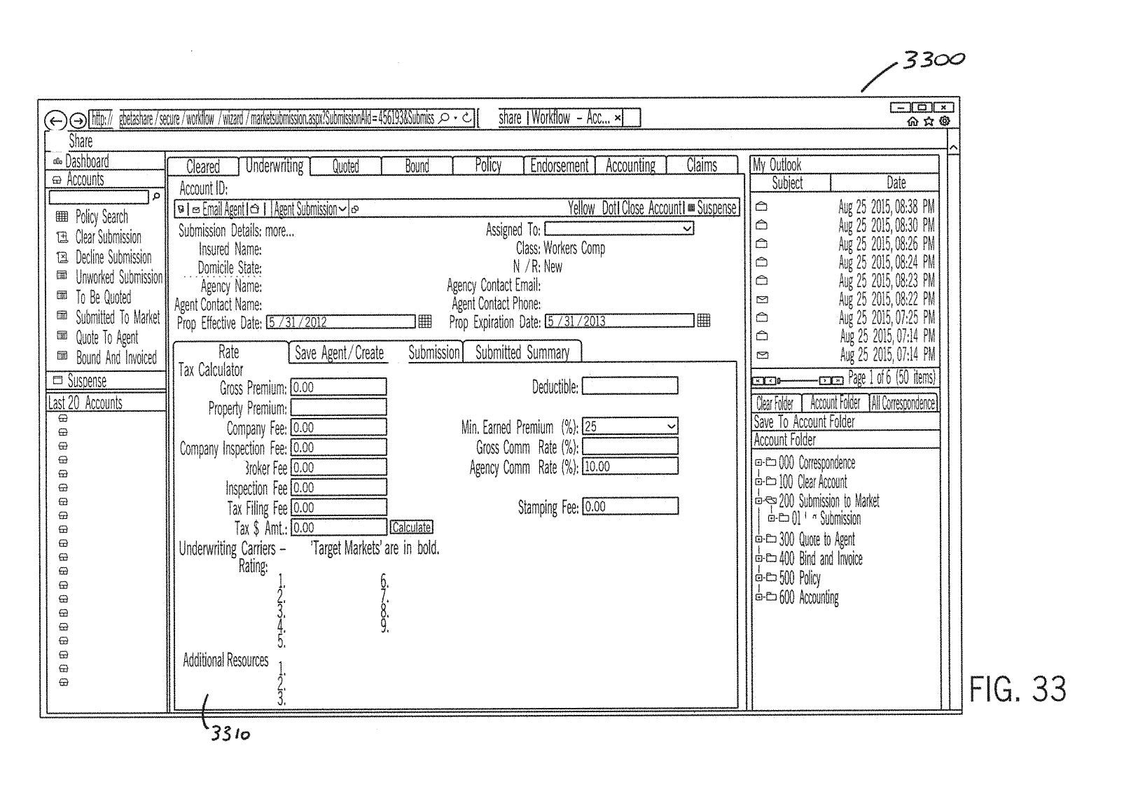

As seen in the screen 3300 of FIG. 33, in some embodiments, a user can generate taxes on an account and use rating tools (in rate tab 3310) to underwrite an account if the use is the binding authority.

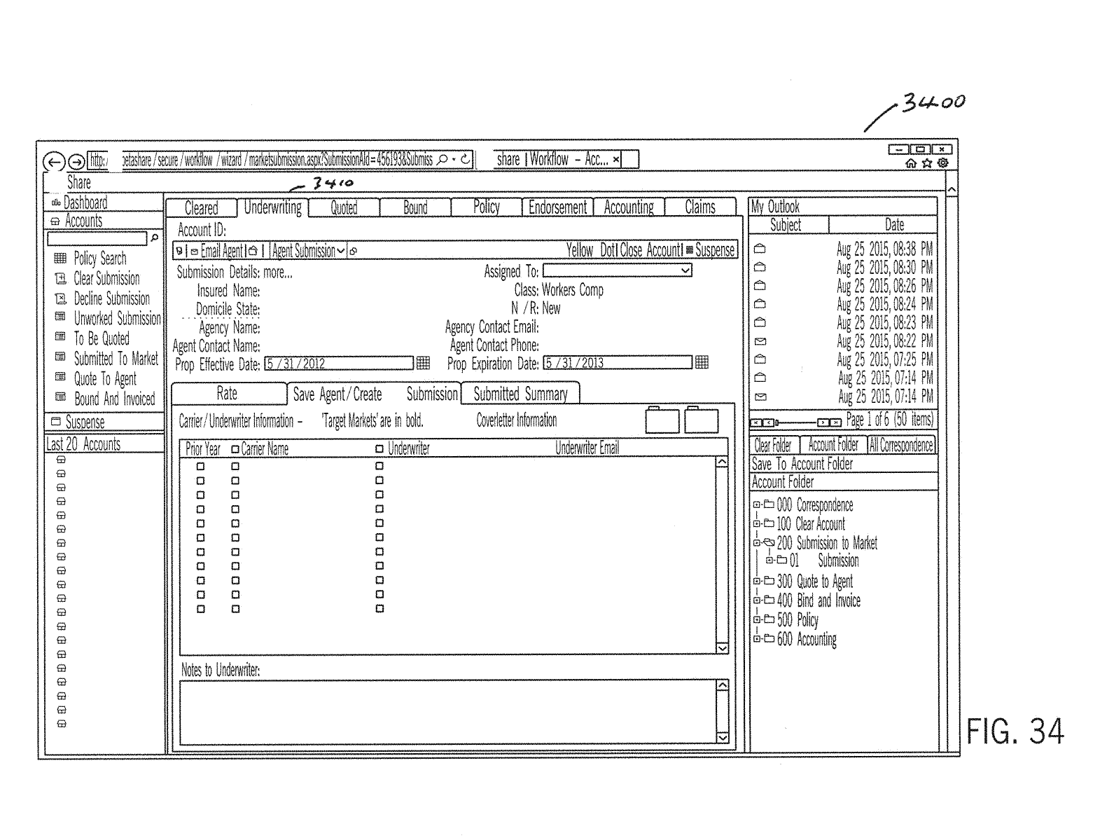

Referring to screen 3400 of FIG. 34, in some embodiments, a user can perform two functions. First, the user can upload a submission and supplemental files and second, the user can choose which market(s) and underwriters to email the submission to using our automated email system (within the underwriting tab 3410). In some embodiments, if a submission is not added to the system the “Preview & Send Submission to Carrier” button 910 may not appear (shown in FIG. 9). In some embodiments, clicking this button can display a form, which can allow the user to select uploaded attachments and preview and send the submission. In some embodiments, all correspondence can be saved in their respected carrier folder in the electronic document library.

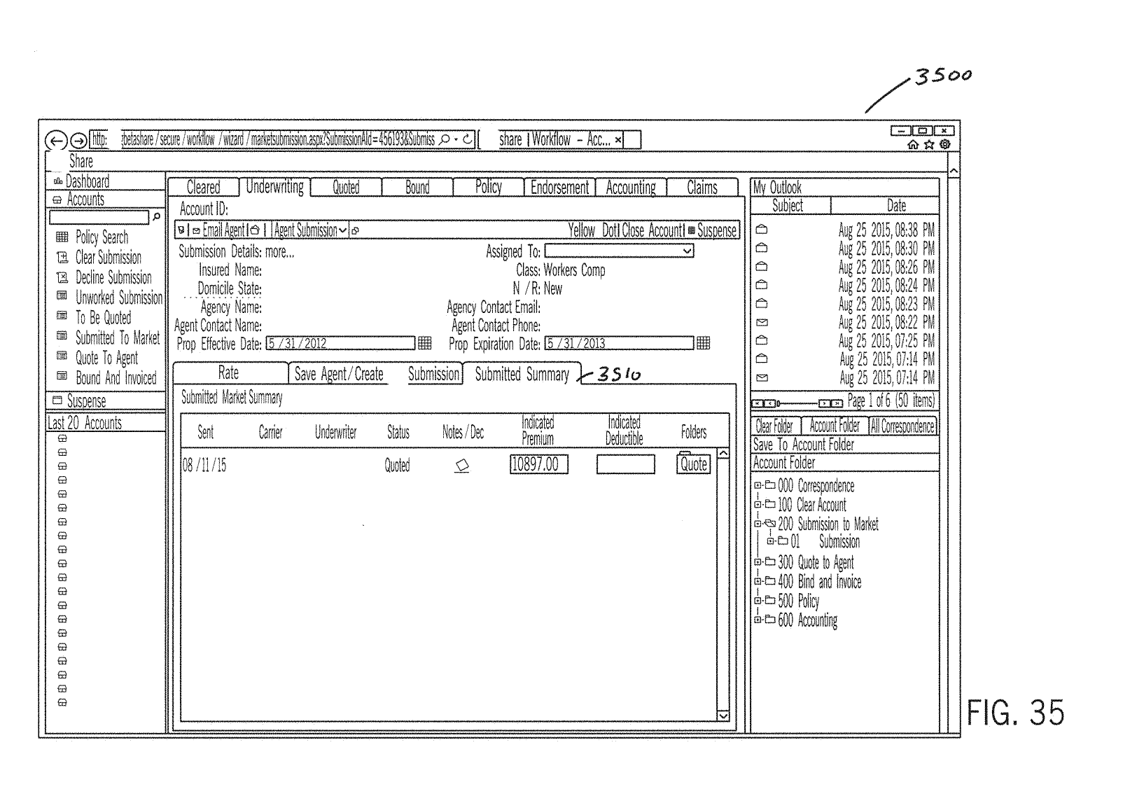

In some embodiments, a user can preview a list of carriers they've submitted the submission in a “Submitted Summary” screen 3500 shown in FIG. 35. In addition, this screen can allow a user to add indicated premium and deductibles (e.g., within the submitted summary tab 3510). In some embodiments, if a quote has been saved, a quote folder can be displayed. In some embodiments, clicking on the folder can open the saved quote.

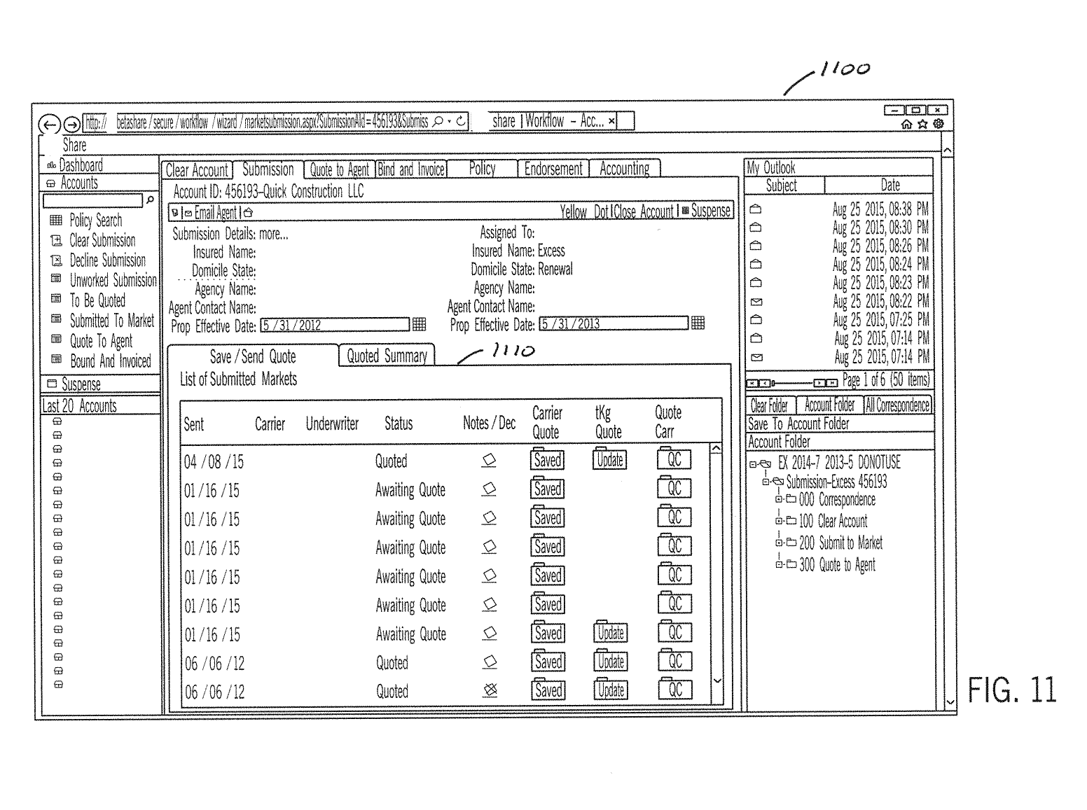

In some embodiments, the “Quote to Agent” screen 1100, generally illustrated in FIG. 11, can be a basic screen to show a list of all carriers and underwriters to whom the submission was sent. In some embodiments, the list can include a “Save” folder to allow the user to drag an email out of the outlook component and into the drop zone of the screen. In some embodiments, this can allow the user to categorize and save all correspondence and attachments into the electronic document system specific to each carrier. In some embodiments, it can also create a duplicate for the broker to redact and send to the agent. The saved/send quote window 1110 can include list of submitted markets information including status and access to folders for saved quotes, quotes, and carrier quotes.

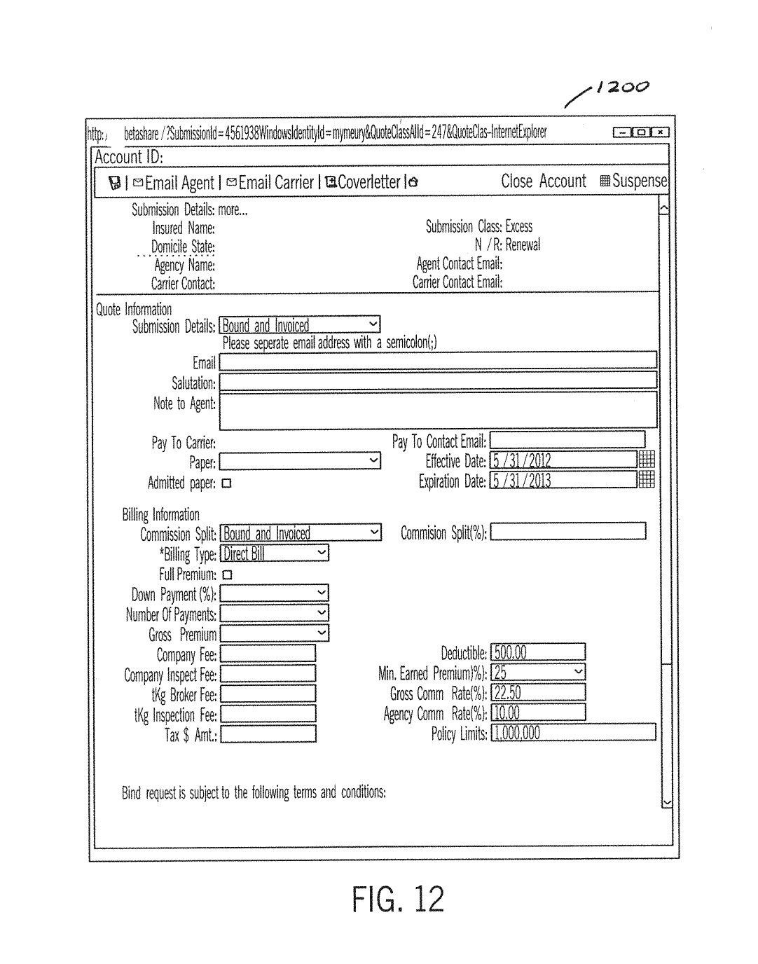

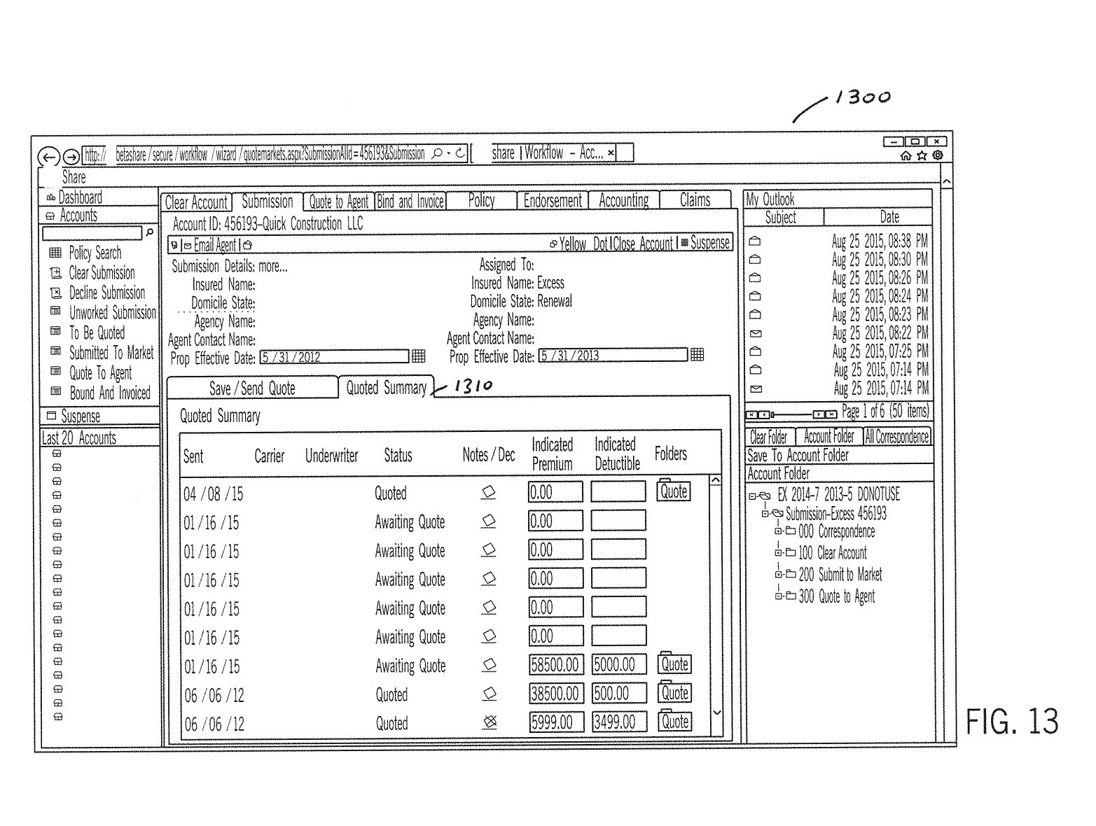

In some embodiments, if a quote has already been saved for a specific carrier, the folder can turn black next to the carrier in the list, and a “Create Folder” icon can appear under the Quote column. In some embodiments, once the user sends out a quote, if there is a new additional quote added to the system, an “Update” folder can appear under the quote column. In other embodiments, the section and/or tab text can be other colors, shades of color, and/or patterned or textured, animated, or a combination thereof. In addition, in some embodiments, the user can make notes or decline a quote by clicking on the note pad icon. In some embodiments, all declined quotes can be displayed on the screen including a red “X” icon. In some further embodiments, the icon can be other colors, shades of color, and/or patterned or textured, animated, or a combination thereof. In some further embodiments, clicking on the “Create” or “Update” folder from the “Quote to Agent” screen 1100 can open up the quote on the left side of the screen, and a data entry form on the right side of the screen, where the quote details can be entered. This is generally illustrated in screen 1200 of FIG. 12. In some embodiments, clicking the “Preview and Send” quote can allow the user to select uploaded documents and send the quote to the agent along with a template email. In some embodiments, the email can be uploaded to the electronic document library. Further, as is generally illustrated in screen 1300 of FIG. 13, a user can view the summary of all the quotes received by clicking on the “Quoted Summary” tab 1310 of the “Quote to Agent” screen, allowing the user to view this information without the need to navigate back to the previous application section.

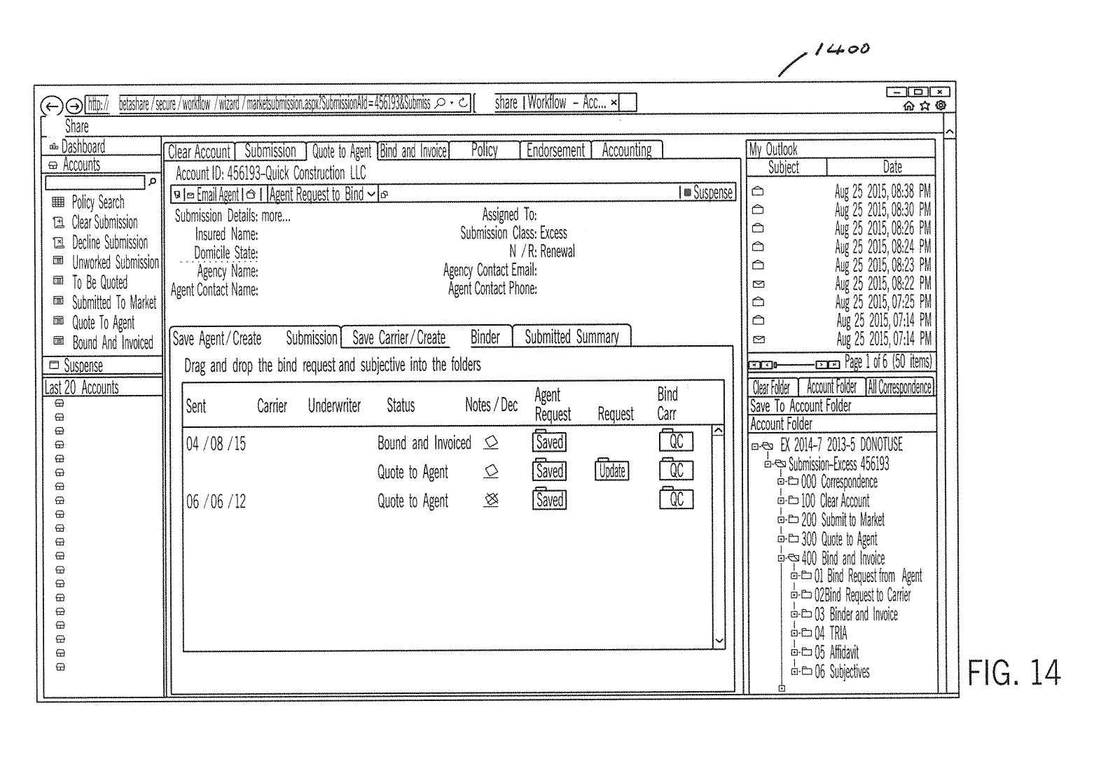

FIG. 14 generally illustrates the ability of a user to drag in a “Request to Bind” from an agent, in which case the correspondence can be saved and filed in the electronic document library. In some embodiments, doing so can allow the user to send a template bind request email to the carrier or underwriter and start packaging the binder for the specific account. In some embodiments, this email can be saved in the file. Once this has been sent, the user can then be able to save a carrier binder in the system. The “Bind and Invoice” screen 1400 of FIG. 14 is a basic screen to show a list of all carriers and underwriters for whom a quote was uploaded and sent to the agent. In some embodiments, the list has a “Save” folder to allow the user to drag an email out of the outlook component and into a drop zone. This can allow the user to categorize and save all correspondence and attachments in to the electronic document system specific to each carrier for the request to bind.

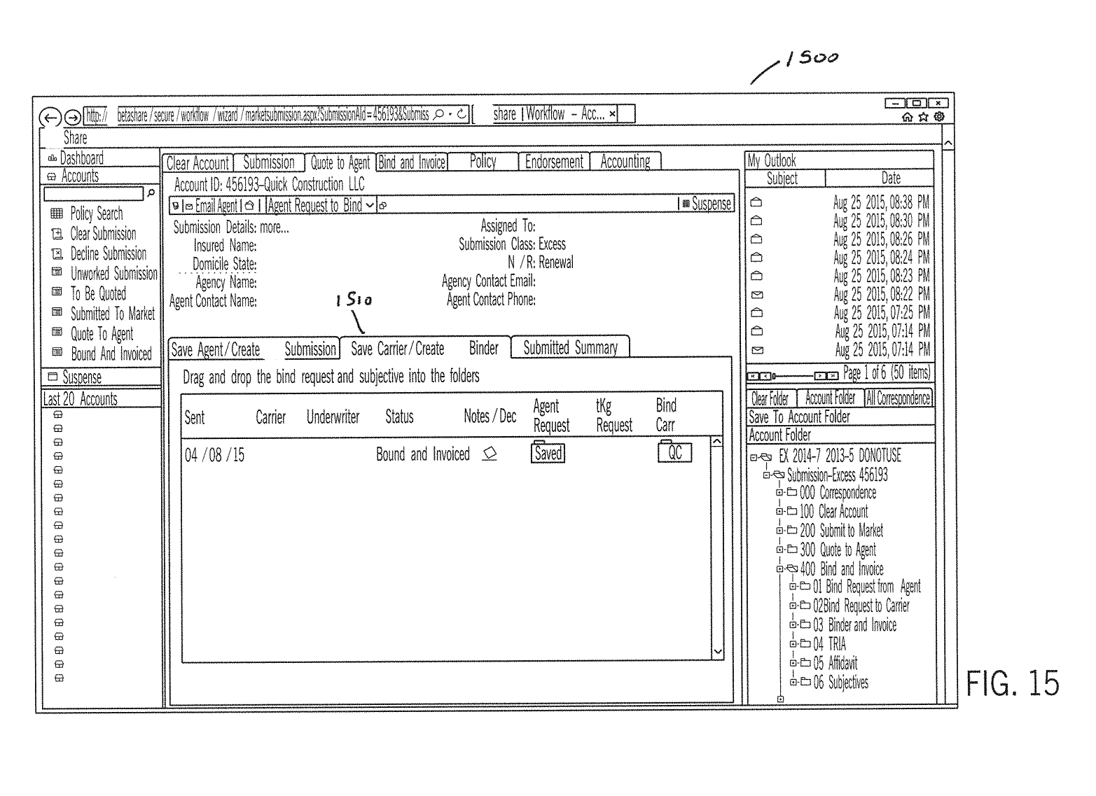

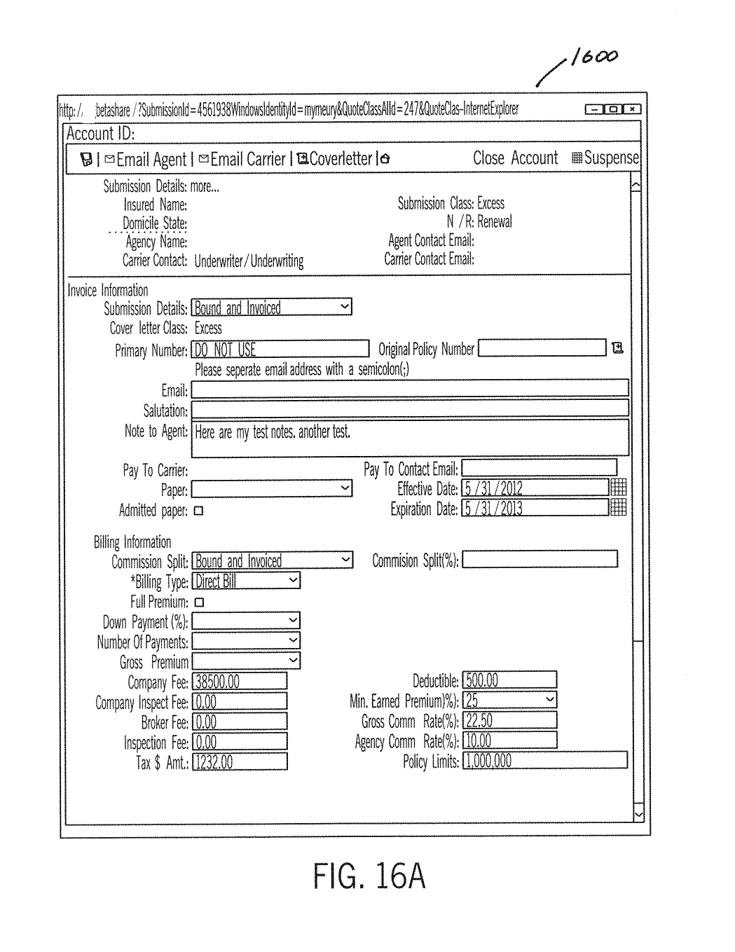

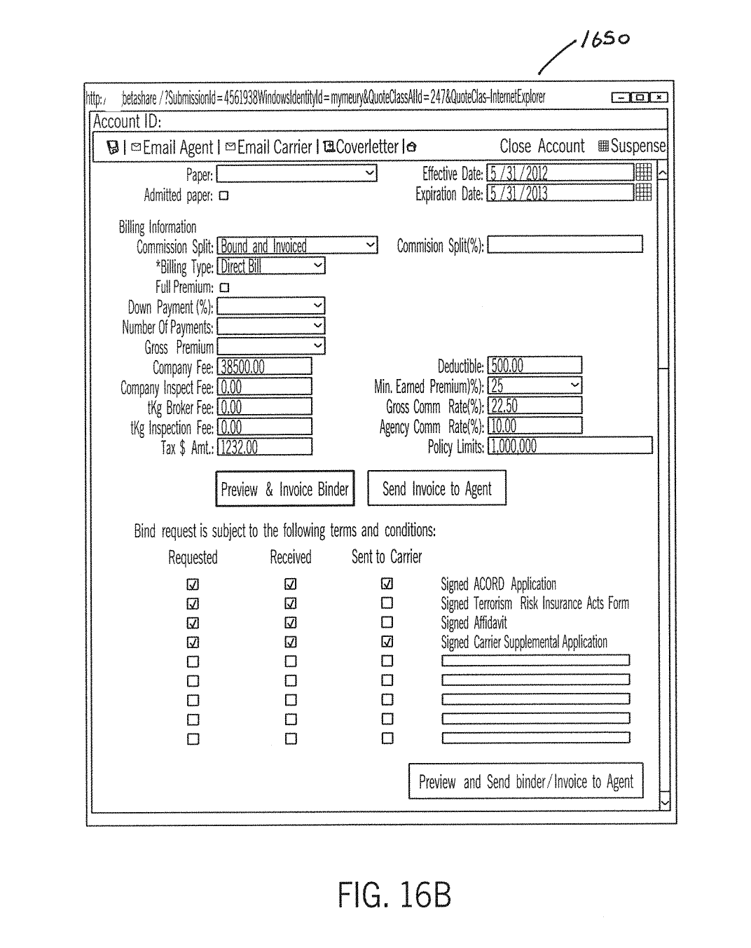

In some embodiments, as shown in FIG. 15, generally illustrating a “Save Carrier/Create Binder” tab screen 1500, some embodiments of the workflow management system can enable a user to drag in a binder from a carrier (e.g., see tab 1510). Doing so can cause correspondence associated with the binder, and the binder itself, to be saved and filed in the electronic document library. In some embodiments, a duplicate binder can be created for the broker to redact and send to the agent, along with an invoice for the account. In some embodiments, the user can then send a template binder email to the agent with the attached invoice. In some embodiments, this email can be saved in the electronic document library. In some embodiments, clicking on the “Create” or “Update” folder on the “Save Carrier/Create Binder” screen can open up the binder on the left side of the screen and a data entry form on the right side of the screen, allowing binder and invoice details to be entered by the user. This is generally illustrated in screens 1600, 1650 of FIGS. 16A and 16B in accordance with some embodiments of the invention.

In some embodiments, clicking a displayed “Preview Invoice Binder” “Save Carrier/Create Binder” can allow the user to preview the invoice generated for the account. In some embodiments, if the invoice is correct, the user can send the invoice to the agent. In some embodiments, if the invoice is not correct, the user can click the “Decline” button to remove the invoice. In some embodiments, the user can then adjust the data and invoice if needed. In some embodiments, after the account has been invoiced, a “Send Invoice to Agent” button can be available. In some embodiments, clicking the “Send Invoice to Agent” can send a template email to the agent, with the invoice attached to the email. In some embodiments, the email can be saved in the electronic document library. In some embodiments, after the account has been invoiced, the “Preview and Send Binder/Invoice to Agent” button can be available. In some embodiments, clicking the “Preview and Send Binder/Invoice to Agent” can send a template email to the agent along with the binder, invoice and any additional attachments to the email. In some embodiments, the email can be saved in the electronic document library.

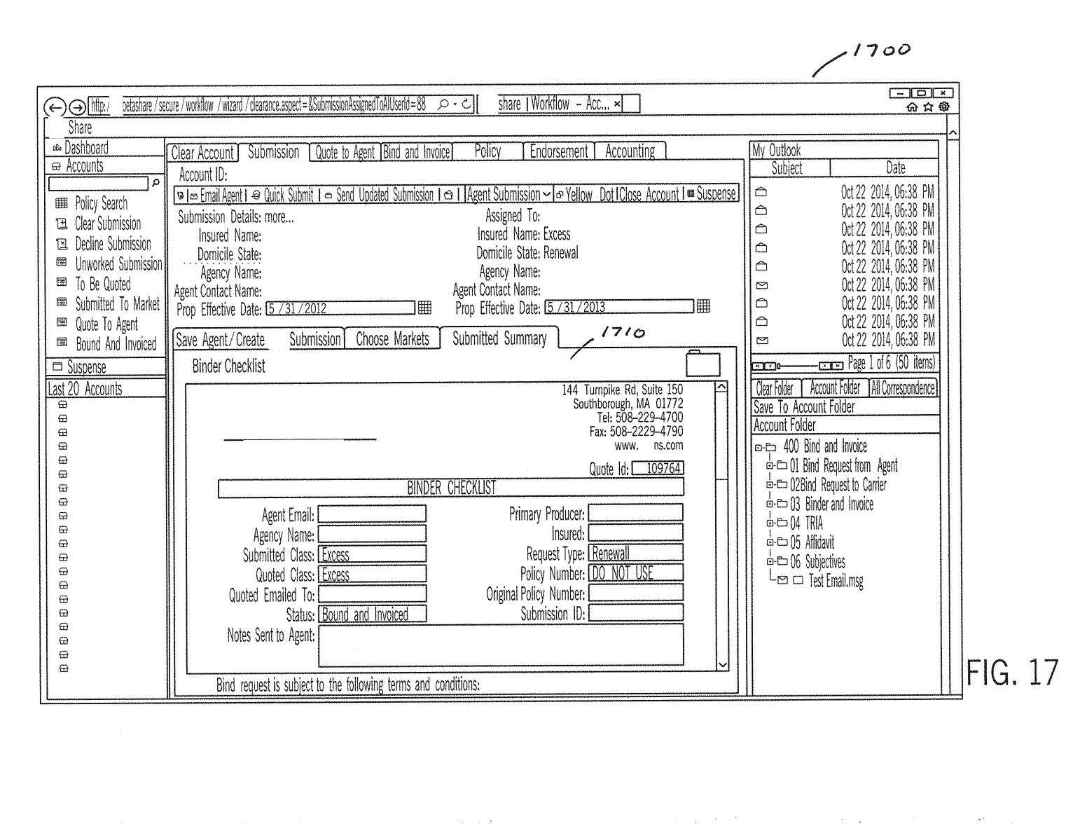

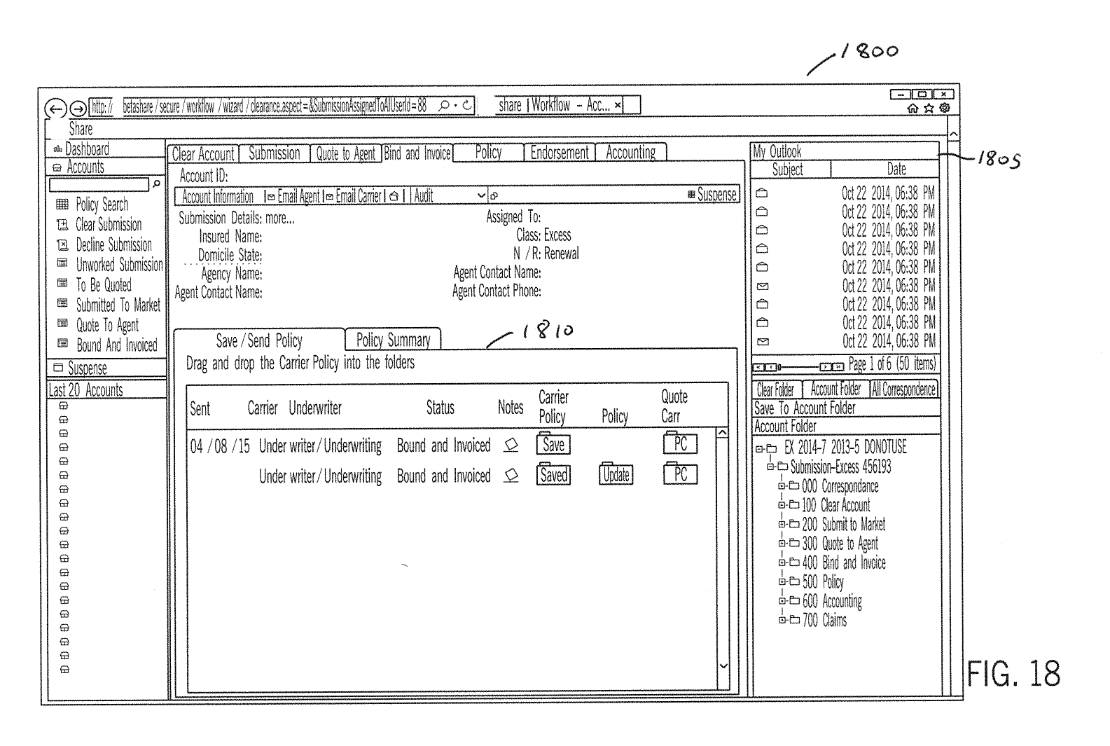

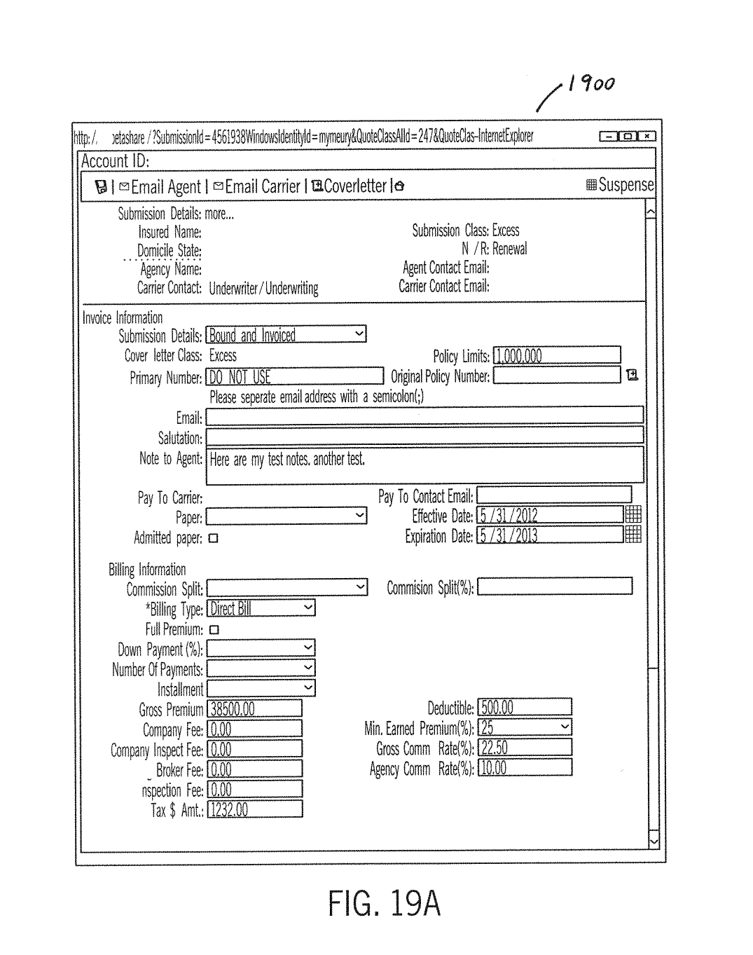

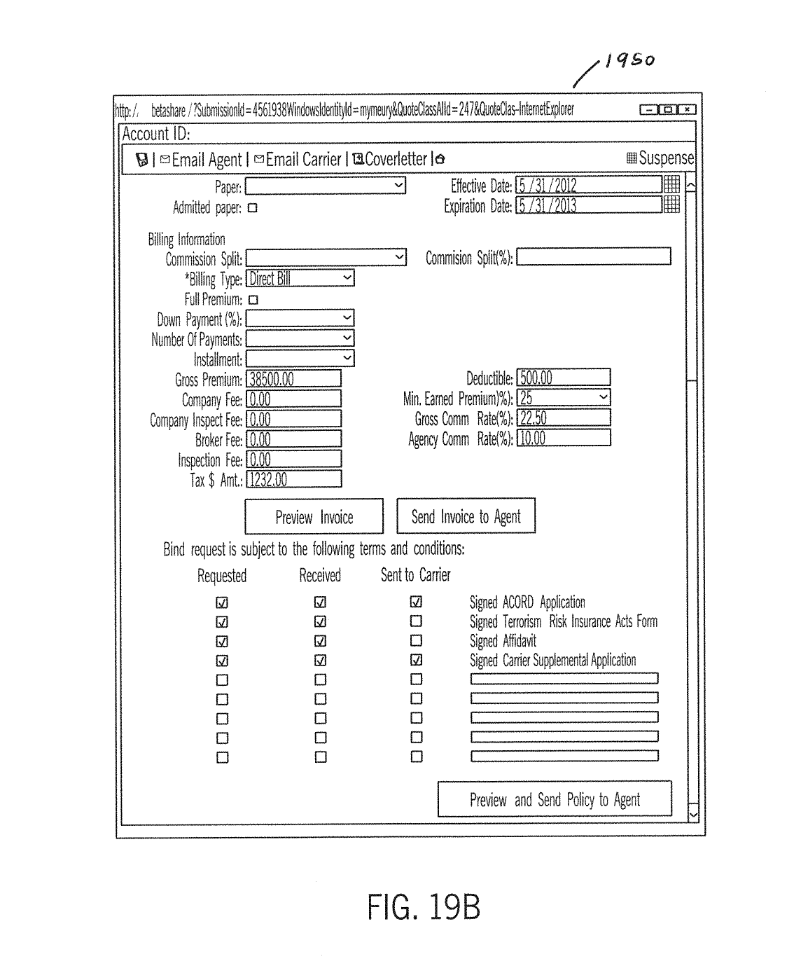

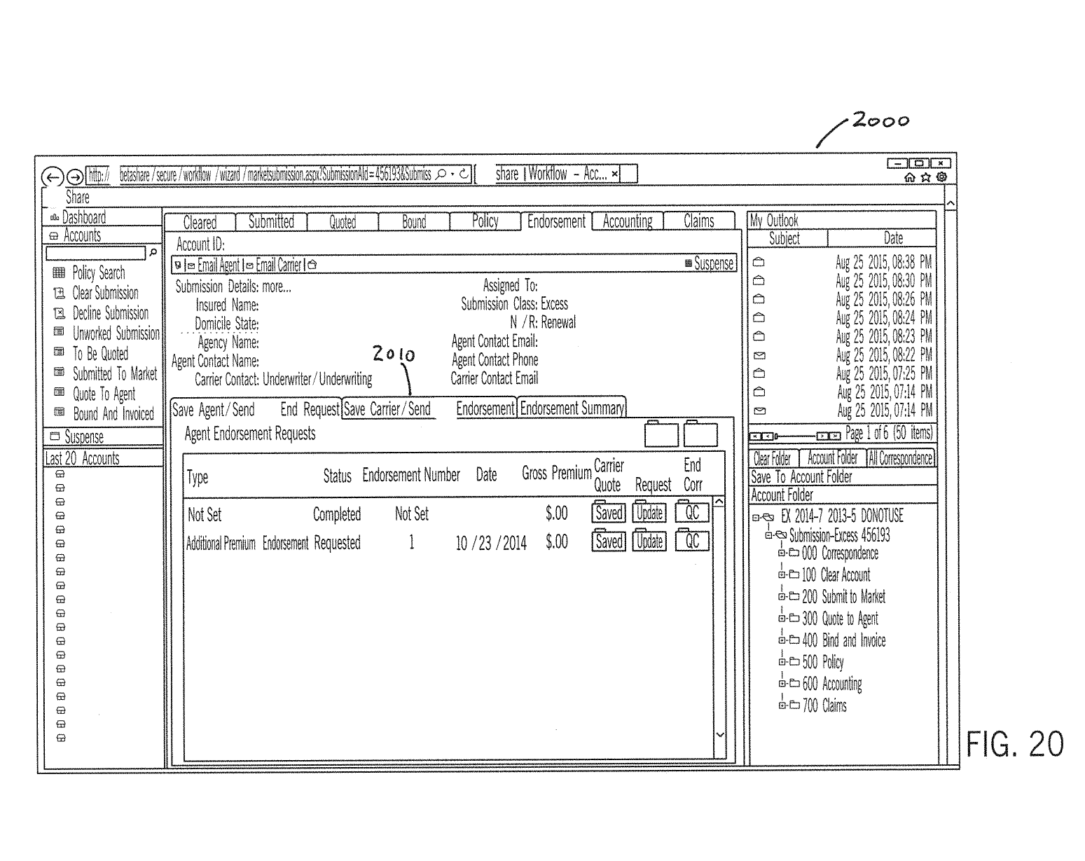

In some embodiments, as depicted in screen 1700 of FIG. 17, a user can review the binder checklist 1710, which contains all the necessary subjectivities needed to bind the account. In some embodiments, the “Policy” screen 1800 illustrated in FIG. 18 is a basic screen to show a list of all carriers and underwriters used to bind an account. In some embodiments, the list has a save folder, to allow the user to drag an email out of the outlook component (1805) and into a drop zone (e.g., into save/send policy tab 1810). In some embodiments, this can allow users to save the policy in the electronic document library specific to each carrier. In some embodiments, if a policy has been saved for a specific carrier, the folder icon can turn black next to the corresponding carrier in the list of carriers, and a “Create” folder icon can appear under the “Policy” column. In some further embodiments, the icon can be other colors, shades of color, and/or patterned or textured, animated, or a combination thereof. In some embodiments, once a user has sent out a policy, any new policies added to the system can cause an “Update” folder to appear under the “Policy” column. In some embodiments, clicking on the “Create” or “Update” folder can open up the policy on the left side of the screen, and a data entry form on the right side of the screen, where the policy details can be entered. This is generally illustrated in screens 1900, 1950 of FIGS. 19A and 19B. In some embodiments, both screens 1900, 1950 can have the same functionality as the bind and invoice page but instead of sending the binder to the agent it can send a template policy email to the agent. In some embodiments, the email can be saved in the electronic document store.

In some embodiments, the “Endorsement” screen 2000 (generally illustrated in FIG. 20) can be a basic screen to show a list of agent or carrier endorsement requests in the workflow management system for a specific account. In some embodiments, a user can save and/or upload correspondence from either the agent or the carrier. In addition, in some embodiments, users can make requests to carriers for endorsements, or send a carrier endorsement to an agent. In some embodiments, a user can drag a request from an agent for an endorsement to the drop area, causing it to be saved and filed in the electronic document library. In some embodiments, this can allow the user to send a template endorsement request to a carrier or underwriter to start the endorsement process. In some embodiments, this email can be saved in the file. In some embodiments, once this has been sent, the user can then save a carrier endorsement document in the workflow management system by selecting the “Save Carrier/Send Endorsement” tab 2010.

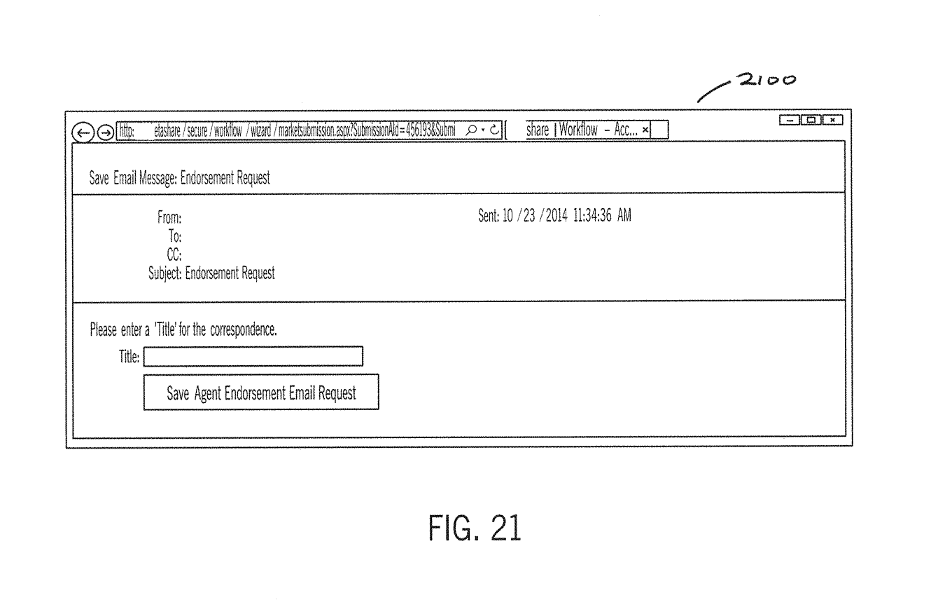

FIG. 21 generally illustrates the screen 2100 selected by the “Save Carrier/Send Endorsement” tab 2010. In some embodiments, on this screen, a user can drag in an endorsement request from an agent, and it can be saved and filed in the electronic document library. In some embodiments, this can allow users to send a template endorsement request email to a carrier or underwriter to start the endorsement process. In some embodiments, this email can be saved in the file.

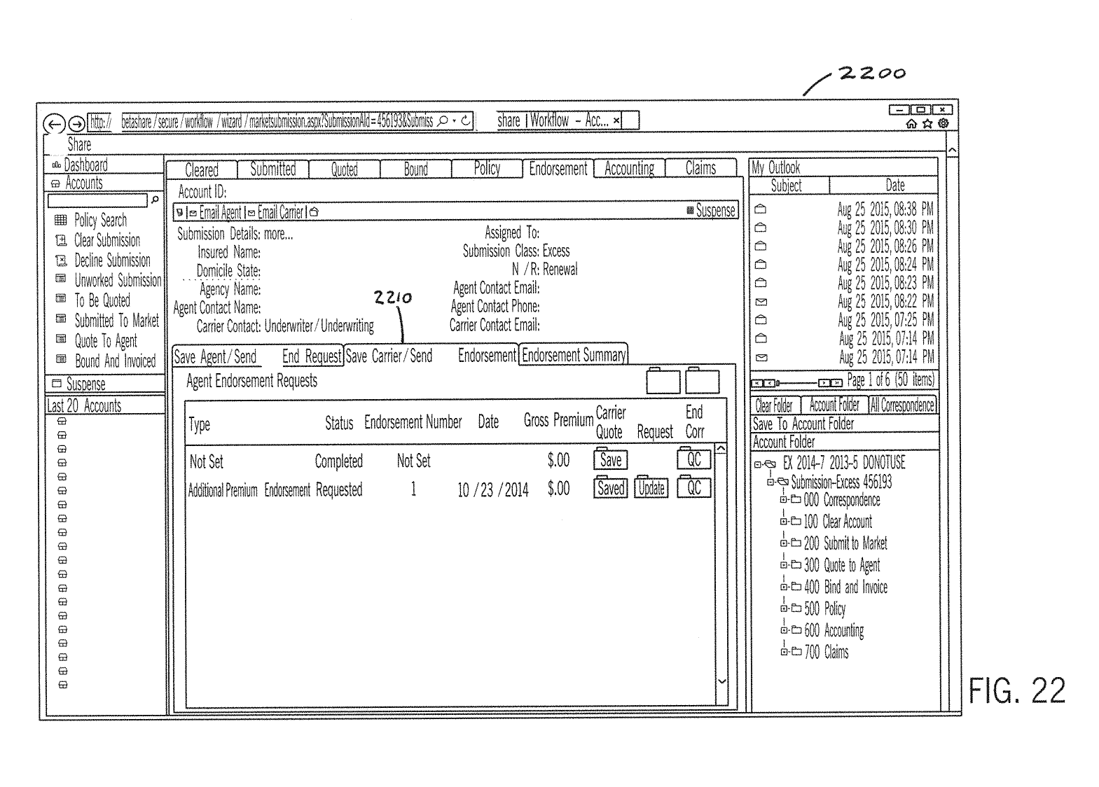

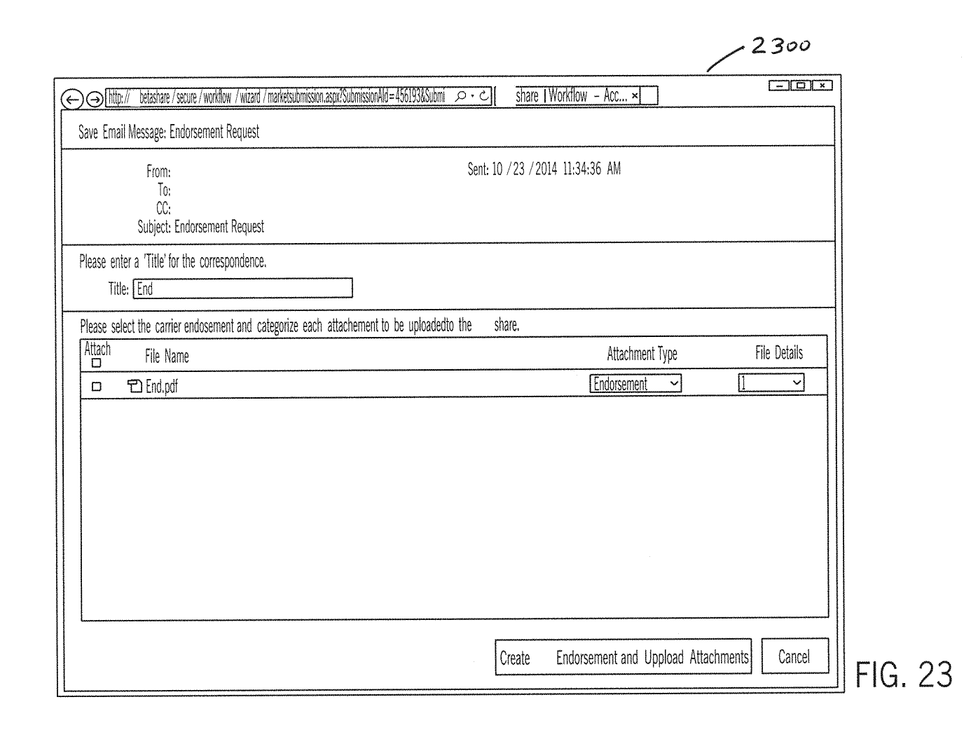

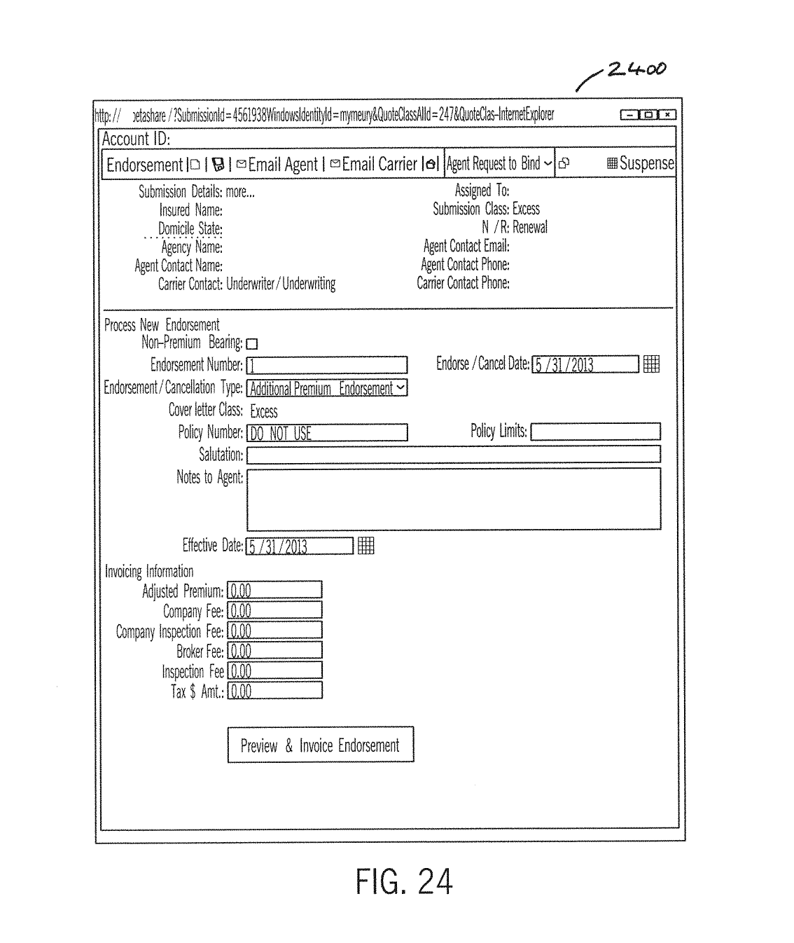

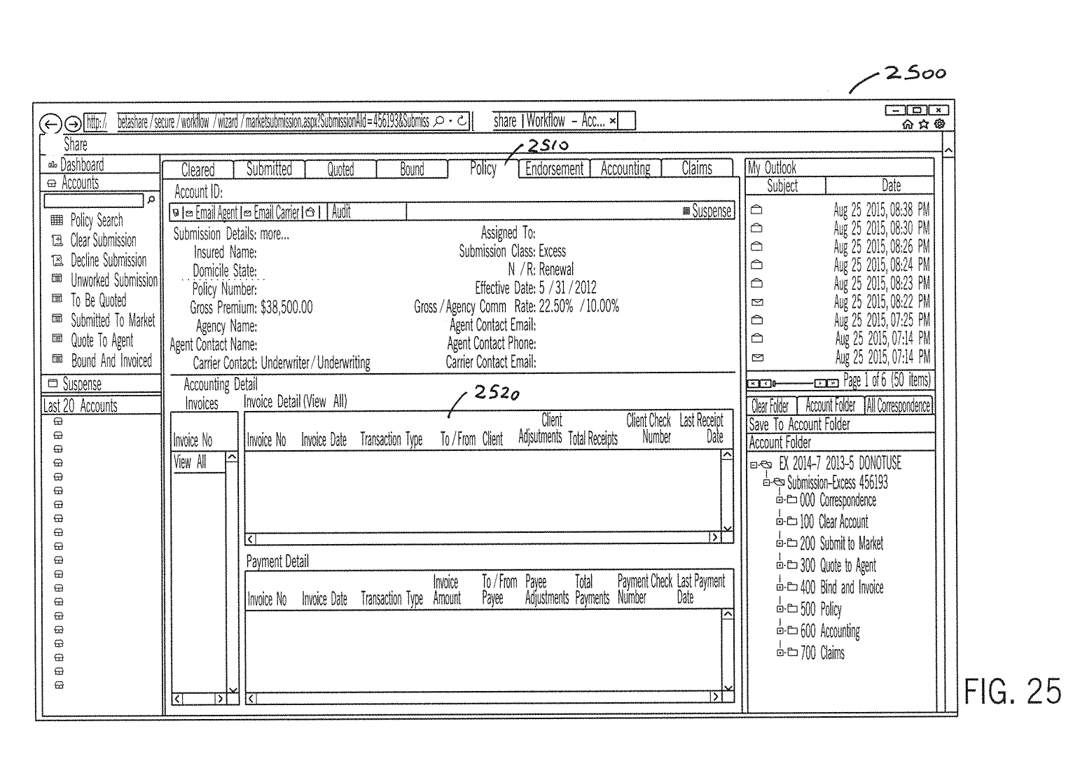

As is generally illustrated in the screen 2200 of FIG. 22, in some embodiments, a user can drag in a request or endorsement from a carrier to be sent to an agent (e.g., within save/send endorsement tab 2210). In some embodiments, if an email containing an endorsement is dragged into the file, the workflow management system can save the endorsement, and create a duplicate endorsement for a broker to redact (e.g., see screens 2300 and 2400 of FIGS. 23-24). In some embodiments, once an endorsement has been attached, a user can send a template endorsement and invoice to an agent. In some embodiments, this email can also be saved in the file. In some embodiments, clicking “Preview & Invoice Endorsement” can allow a user to send the endorsement to an agent. In some embodiments, the “Accounting” screen 2500, generally illustrated in FIG. 25, is a basic screen showing financial information on an account. In some embodiments, from this screen, users can view and send invoices to the agent. For example, from the policy window 2510, an accounting detail window 2520 can tabulate accounting details including invoices and payments.

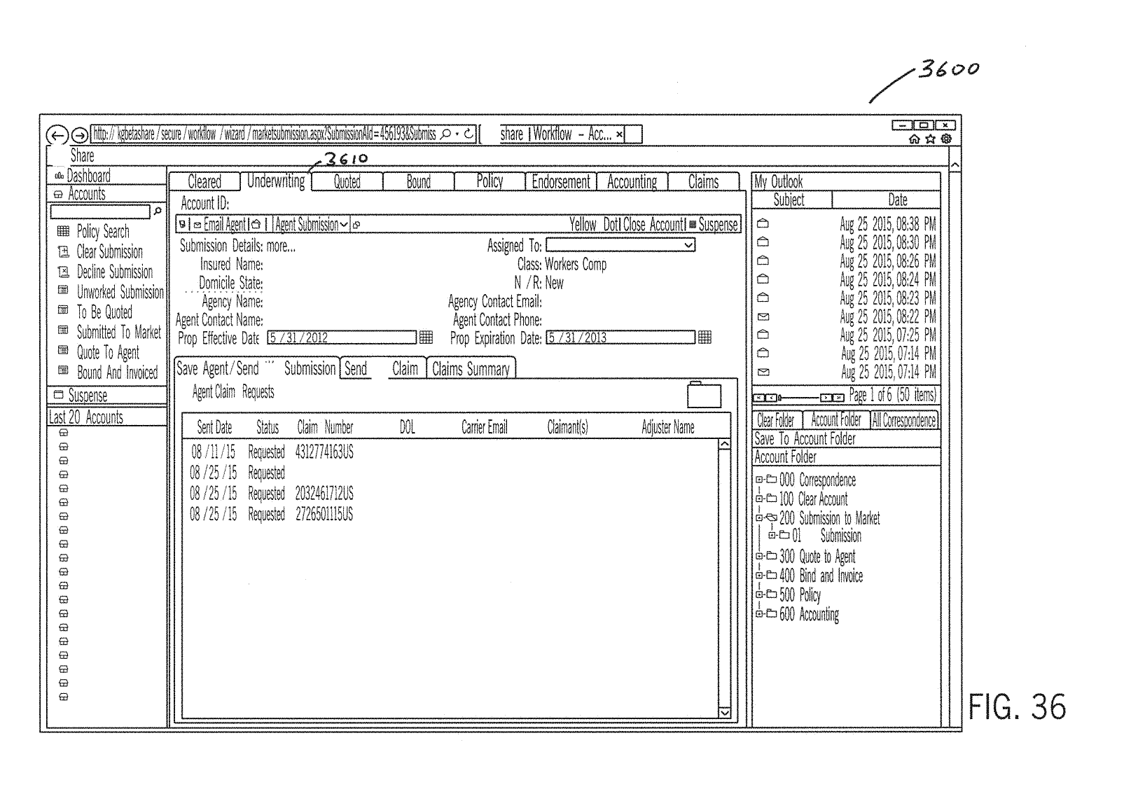

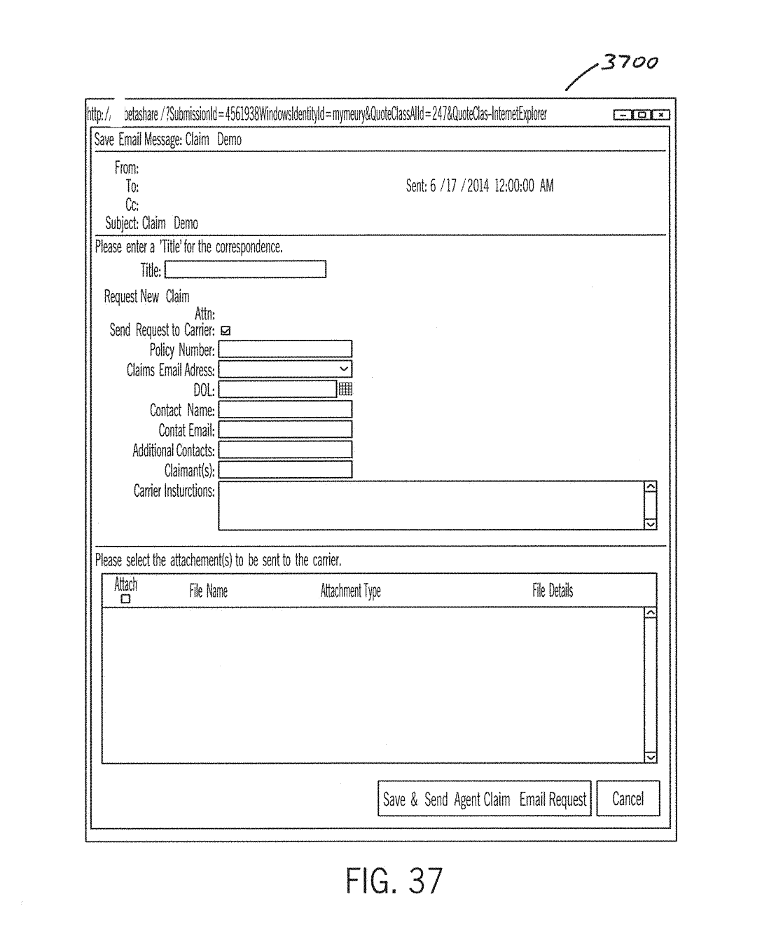

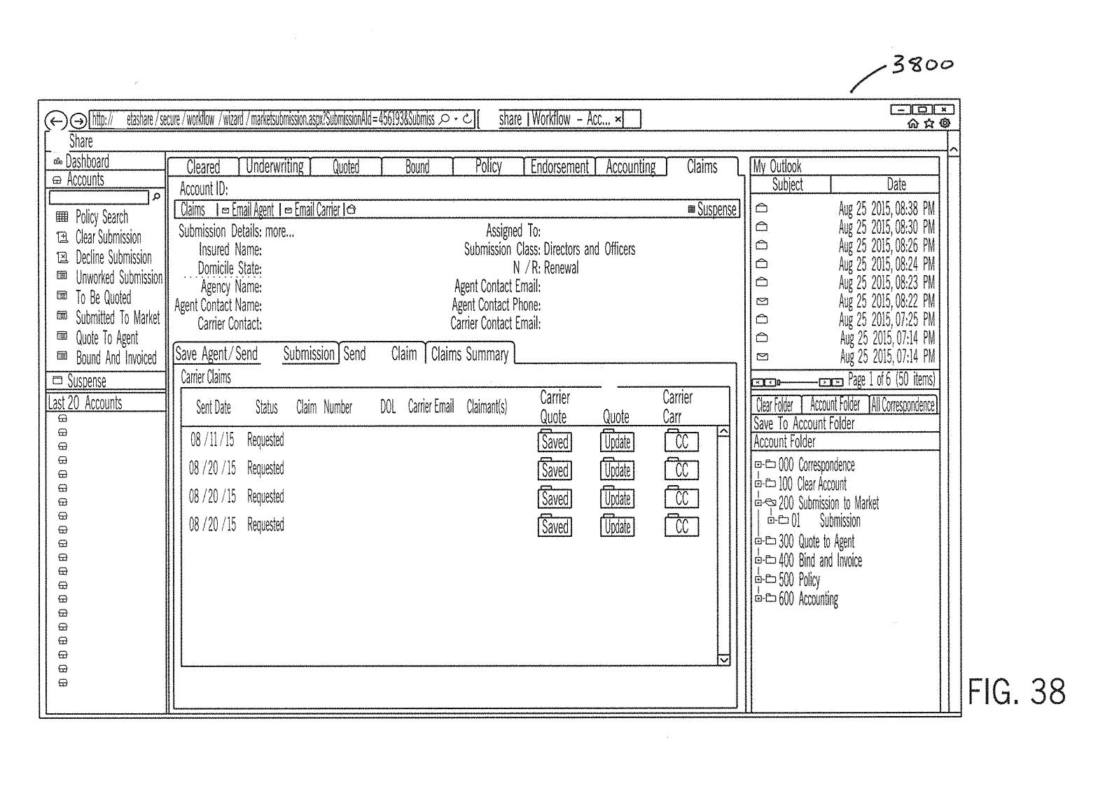

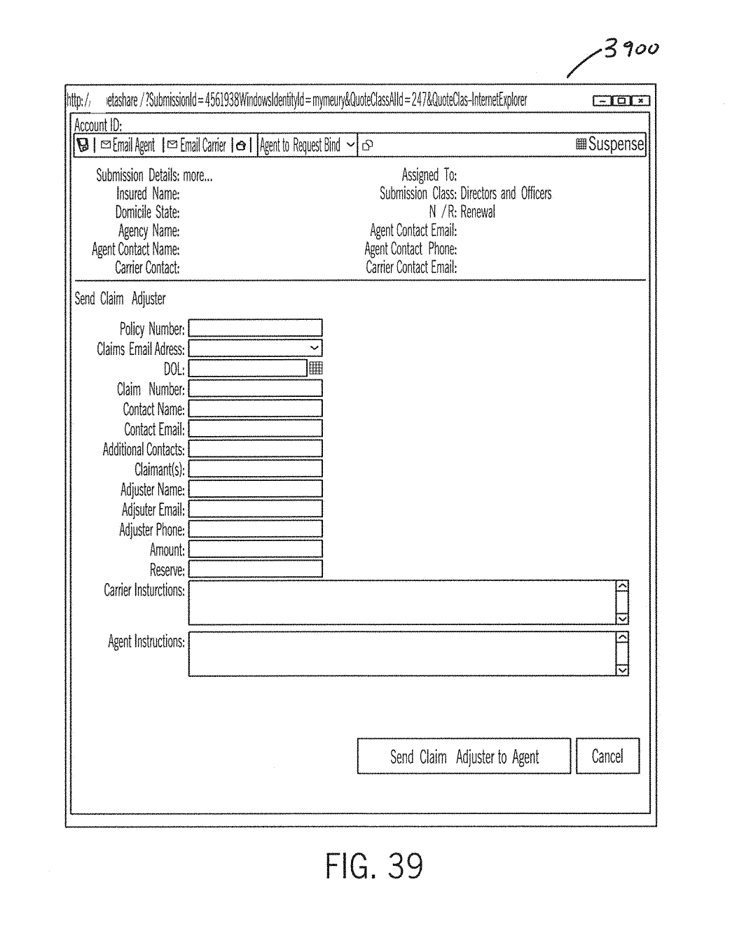

In some embodiments, the user can save and upload correspondence from either the agent or the carrier. In addition, in some embodiments, they can make requests to carriers for claims or send a carrier claim adjuster to an agent. In some embodiments, a user can drag in a request from the agent for a claim and the correspondence can be saved and filed in the electronic document store. In addition the user can enter additional details about the claim. In some embodiments, the user can send a template claim request to the carrier or underwriter to start the claim process (see underwriter tab 3610 of screen 3600 of FIG. 36). In some embodiments, this email is automatically saved in the file. In some embodiments, once this has been sent, the user can then be able to save the carrier claim adjuster information in the system under the “Send Claim” tab, which directs the user to a claim request screen 3700, shown in FIG. 37. In some embodiments, as seen in “Send Claim” screen 3800 of FIG. 38, a user can drag in the claim adjuster information sent to the user from the carrier who is assigned to the claim. In addition, the user can send the adjusters information to the agent and the system displays the assignment screen 3900, shown in FIG. 39.

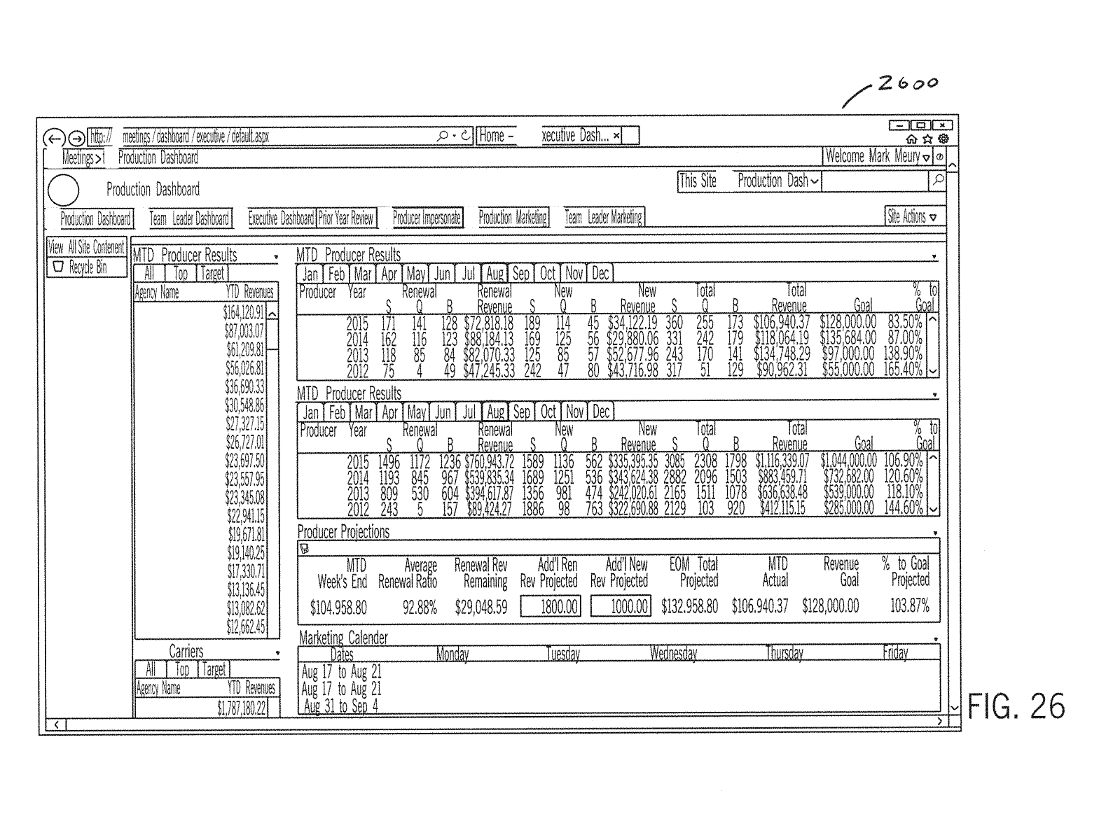

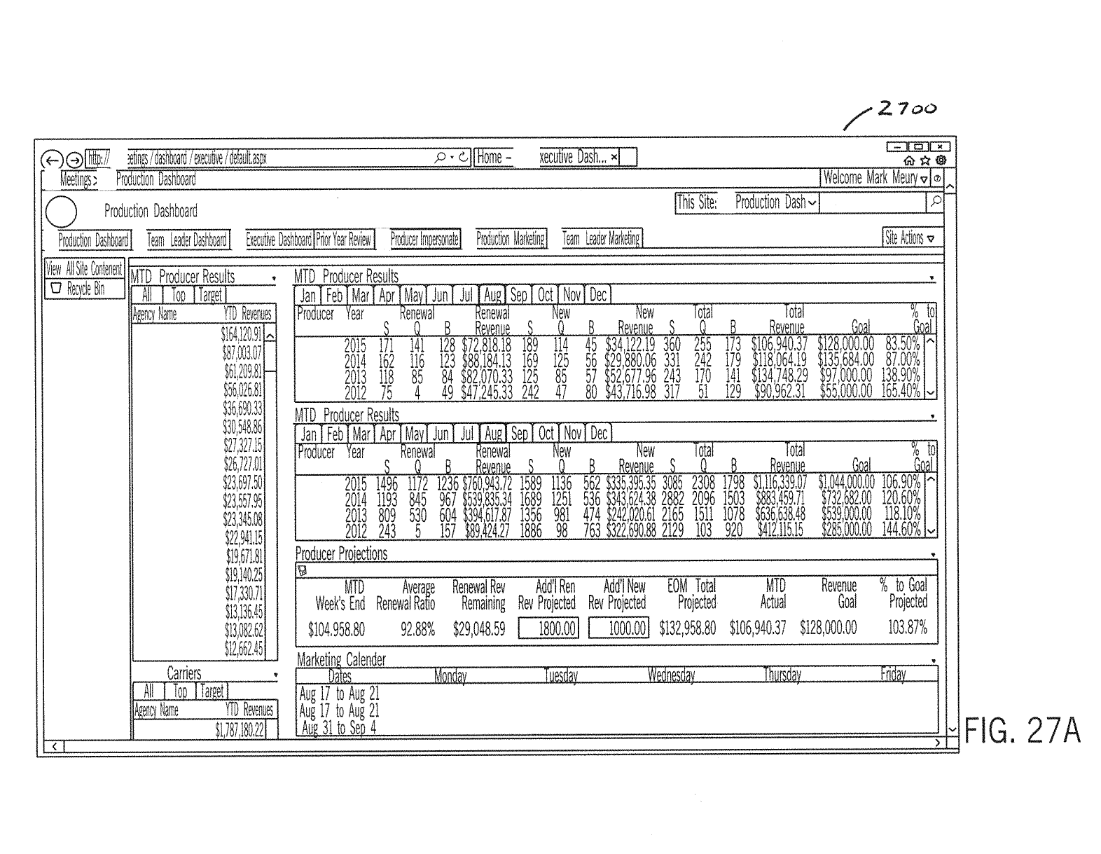

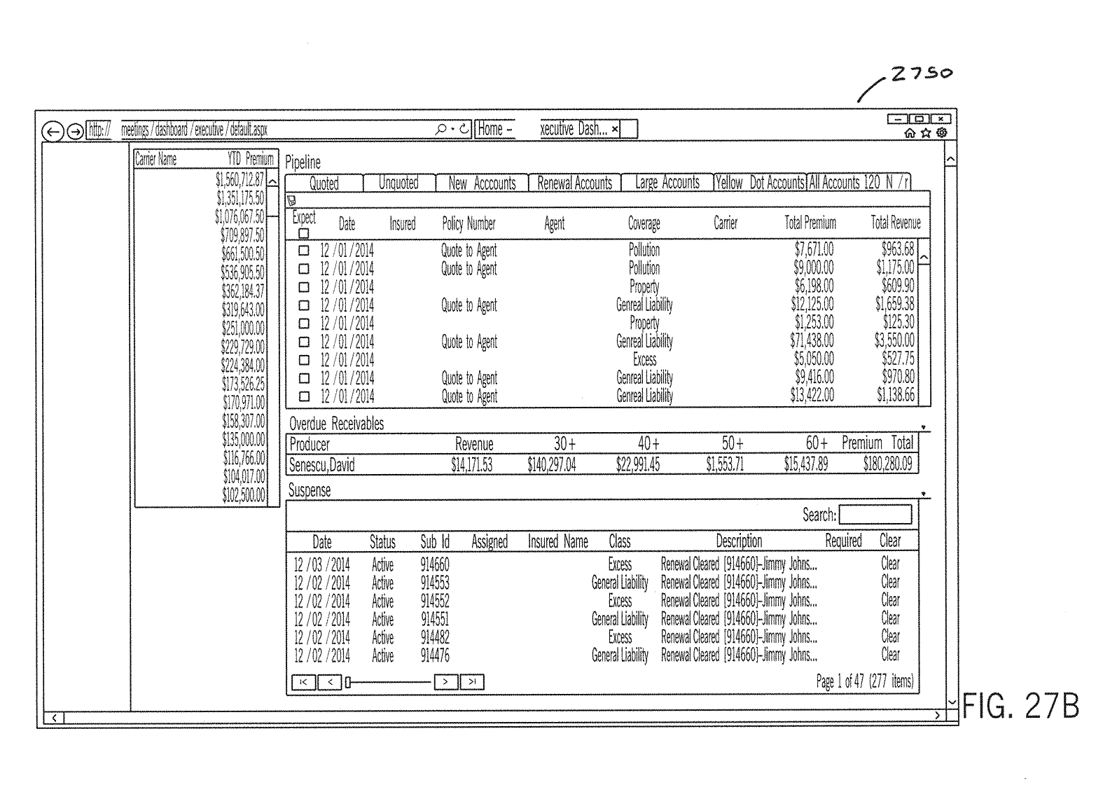

In some embodiments, the production dashboard, shown in screen 2600 of FIG. 26, can allow a producer, team leader or the executive team the ability to manage the workflow by a company, team or individual basis. Some embodiments of the invention can include three unique dashboards for each hierarchical level. In some further embodiments, the “Producer Dashboard” screen, as shown in the screens 2700, 2750 of FIGS. 27A-27B can be a basic screen to show a producer an overview of their accounts. The dashboard has widgets to show retail agencies revenues, carriers premiums, month to date results, year to date results, producer monthly projections, marketing calendar, pipeline, overdue receivables and suspense items all in real-time. In some embodiments, they also have the ability to drill down on each widget to get additional details.

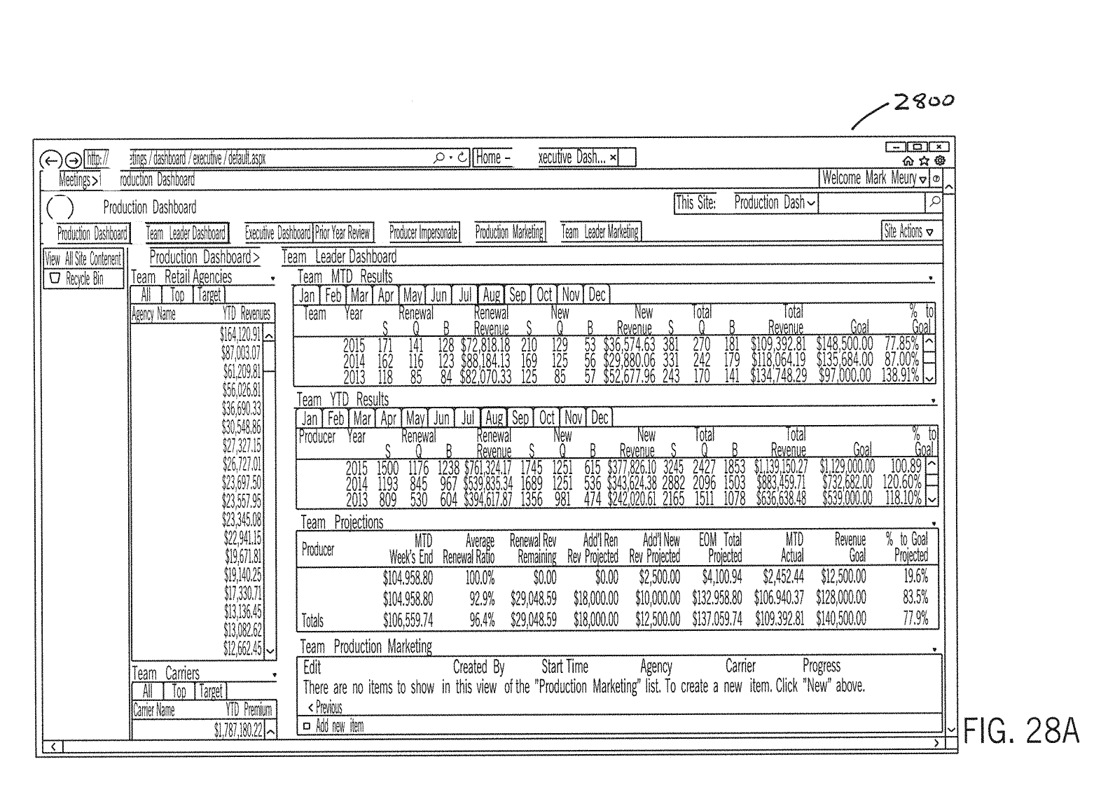

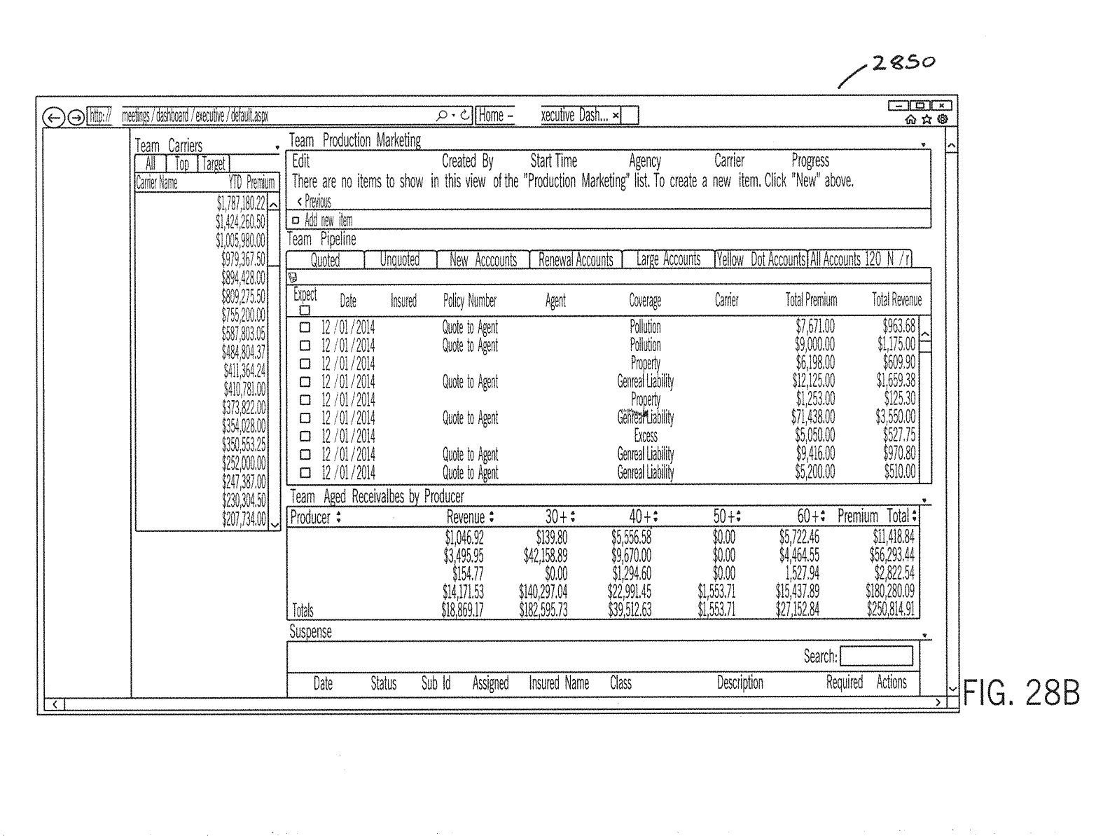

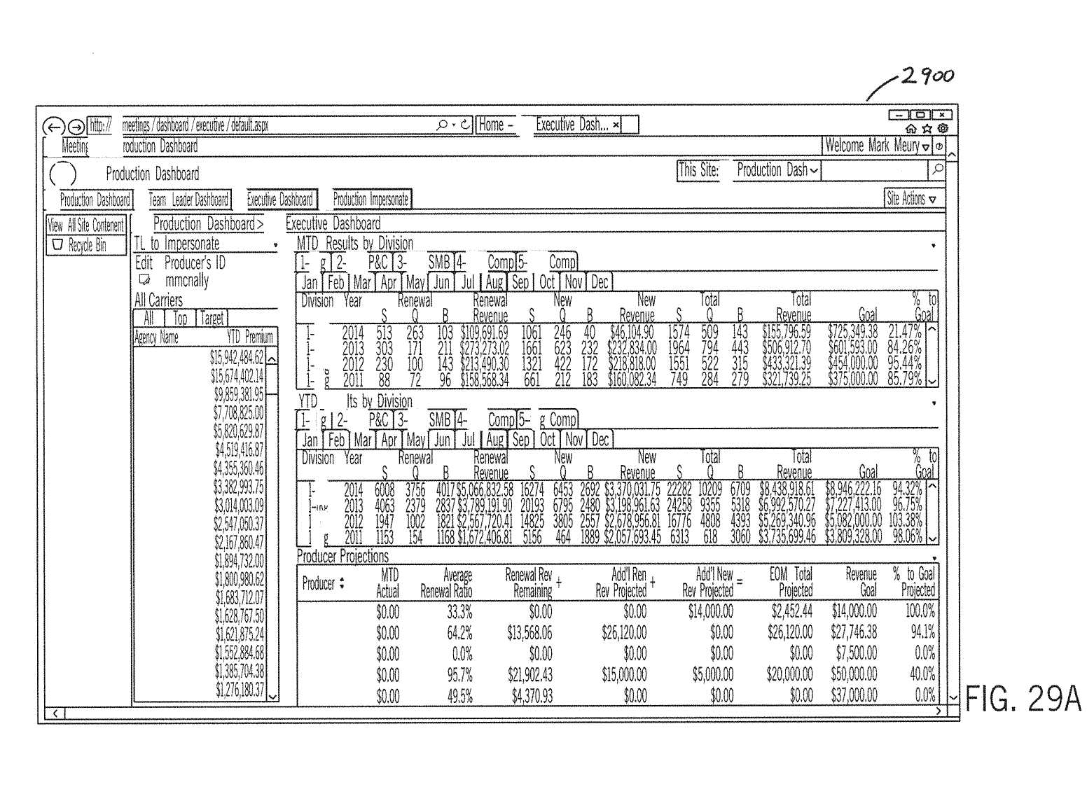

In some embodiments, the “Team Leader Dashboard” screen, shown illustrated in screens 2800, 2850 of FIGS. 28A-28B, can be a basic screen to show a team leader an overview of their team accounts. The dashboard has widgets to show retail agencies revenues, carriers premiums, month to date results, year to date results, producer monthly projections, marketing calendar, pipeline, overdue receivables and suspense items all in real-time. They also have the ability to drill down on each widget to get additional details.

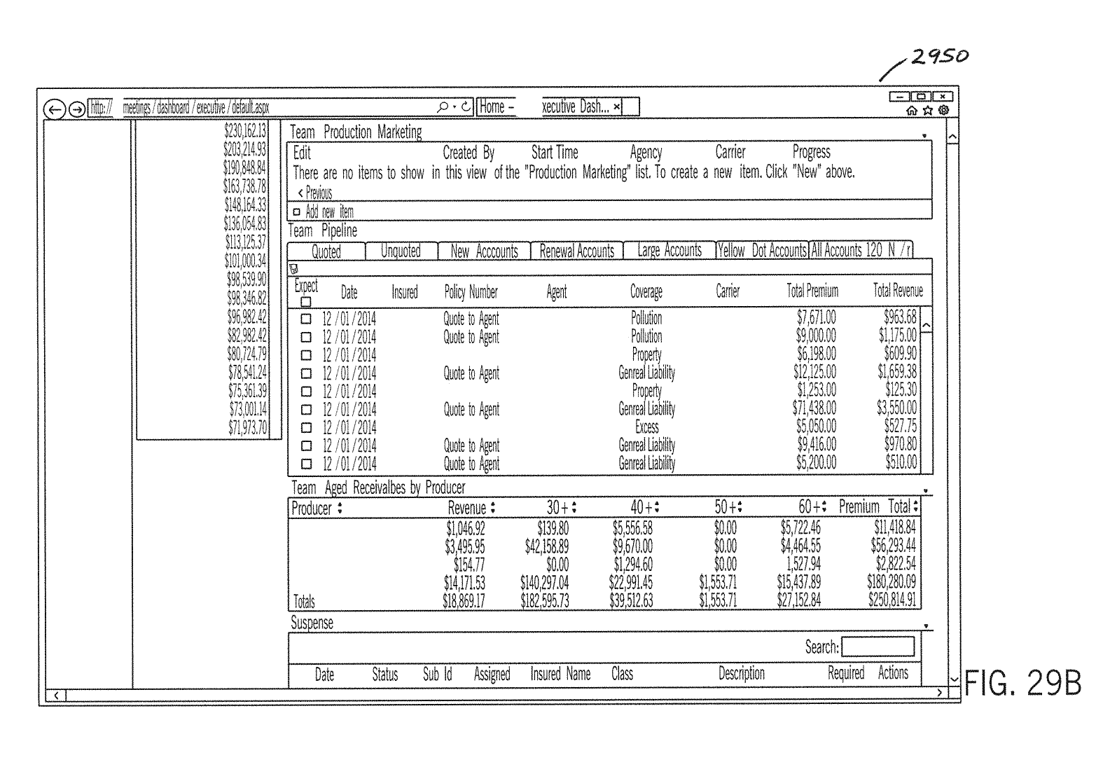

In some embodiments, the “Executive Dashboard screen,” shown in screens 2900, 2950 of FIGS. 29A-29B, can be a basic screen to show an executive an overview of the division accounts. In some embodiments, the dashboard can include widgets to show retail agencies revenues, carriers premiums, month to date results, year to date results, producer monthly projections, account reconciliation, and overdue receivables all in real-time. They also have the ability to drill down on each widget to get additional details.

In some embodiments, the folder structure of the electronic library is a useful component of the workflow management system. In some embodiments, the server can operate and execute instructions of code (software) to automatically create a folder structure within an electronic library, where each folder structure is associated with a particular account. In some embodiments, the structure includes automatic naming of folders and subfolders within the folder structure. In some embodiments, each named folder of the workflow management system can be associated with a particular aspect or transaction required to process or manage an account. In some embodiments, the workflow management system can operate to automatically save emails to the proper folder of the electronic document library.

For example, in some embodiments, when a user clicks on a button to send an email, the server can execute code to provide a screen on the display of the user terminal prompting the user to select the folder in which to save the email. Upon completion of typing the email and clicking on send, the server can execute code to save the email into the previously selected folder. In some embodiments, this saving of emails ensures proper documentation of all communications sent electronically through the system. This is helpful in audits, and provides other beneficial uses related to information retrieval and communication tracking.

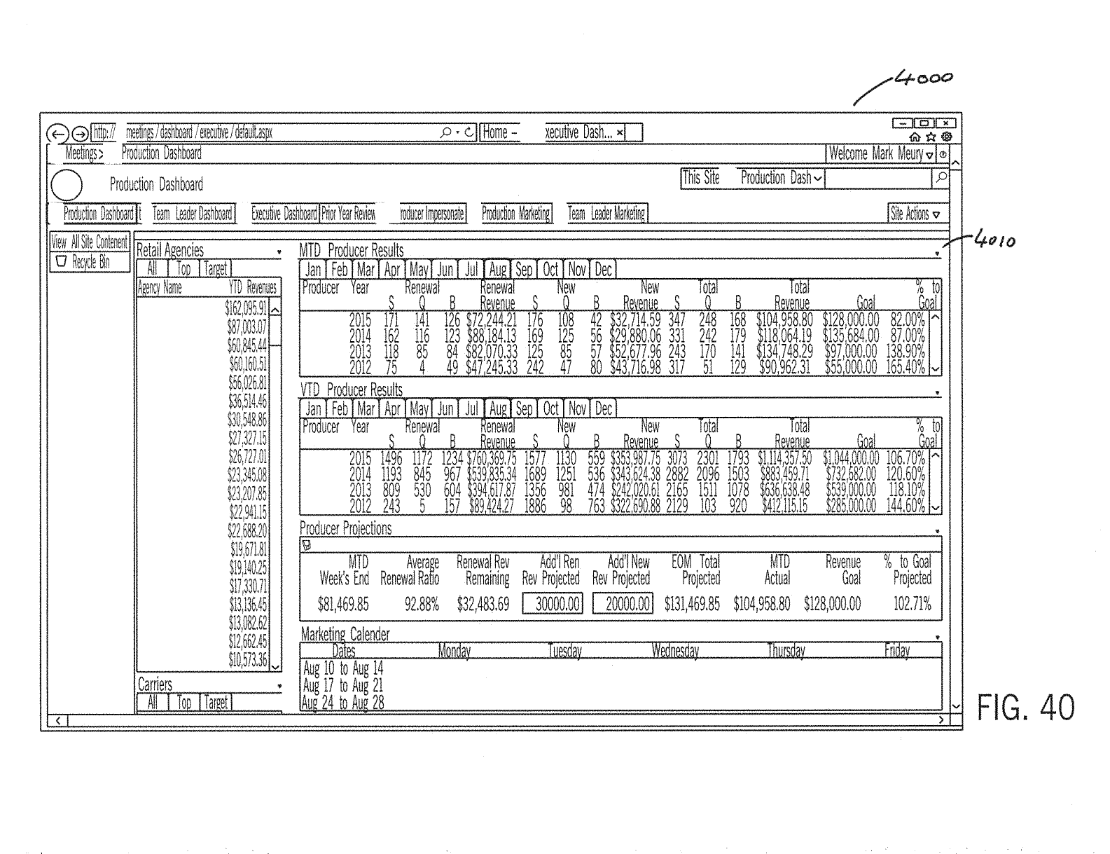

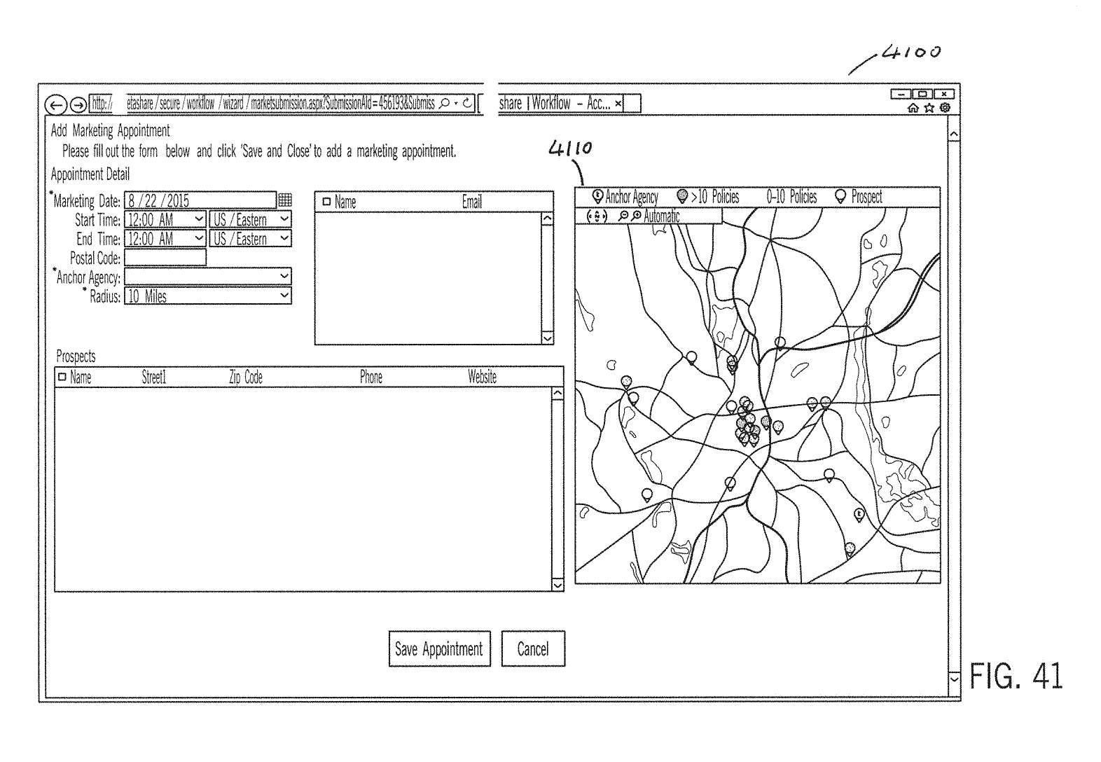

In some embodiments, the “Marketing Calendar,” 4010 as seen in screen 4000 of FIG. 40, displays agency visits for the current, previous and next week for a producer. In some embodiments, the user can use the interactive marketing tools to identify marketing opportunities when the user schedules a visit with an agency. Further, referring to the “Add Marketing Appointment” screen 4100 in FIG. 41, in some embodiments, a user can search for agencies in a particular area to schedule a marketing visit using map screen 4110. In some embodiments, a user can schedule a marketing appointment on the user's marketing calendar and provide the user with an exportable calendar entry, such as but not limited to, an Outlook calendar entry, which includes navigation links to provide the user with turn by turn directions to the user's appointment.

In some embodiments, according to embodiments, the invention can include a method of processing and managing an account during the life-cycle of the account. In some embodiments, the method can comprise providing a software application stored and operated on a computing device, where the software application provides an account workflow, and a user interface for each required step to process an account. The steps can comprise a specific sequence of steps of clearance, followed by submit to market, followed by quote to agent, followed by bind and invoice, followed by endorsements, followed by accounting, and followed by claims. In some embodiments, the method can also include controlling a user's access to the required steps to process the account with the software application, where the software application controls the user's access by restricting access to and data entry through the user interface associated with a particular step until a previous step is completed. The method can also include automatically creating a unique folder structure for an account in response to the computing device executing instructions of code of the software application to automatically create the unique folder structure within an electronic library stored on a hard drive of the computing device, wherein each folder structure is associated with the account, and the folder structure includes automatic naming of folders and subfolders within the folder structure.

In some embodiments, the method further comprises automatically saving emails sent through the system in a folder of the folder structure of the electronic library in response to executed code of the software application by the computing device.

In some embodiments, the method can further comprise providing a drag and drop feature in the software application. Operating the drag and drop feature, wherein operating the drag and drop feature operates comprises dragging an electronic file into a user interface of the software application and automatically saving the electronic file in a folder of the folder structure corresponding to the electronic file. In some embodiments, the method can also comprise automatically creating a copy of the dragged electronic file for the user to redact in response to dragging the electronic document and dropping it in an active window of the user interface.

In some embodiments, the method can further comprise automatically creating a letter in response to a user selected input, wherein the form is based on information input into the software application through the user interface. The method includes automatically displaying a form screen for data entry, wherein the form screen corresponds to the letter, wherein the method further comprises automatically editing the letter in response to adding or changing the data input in the form screen. Further still, in some embodiments, the method further comprises automatically reviewing the processing of the account for quality assurance for admitted and non-admitted policies, wherein reviewing the processing of the account comprises automatically determining by execution of the software product that certain required components of a policy submission are present.

As can be appreciated by one skilled in the art, aspects of the invention can be embodied as a system, method, or computer program product. Accordingly, aspects of the invention can take the form of an entirely hardware embodiment, an entirely software embodiment (including firmware, resident software, micro-code, etc.) or an embodiment combining software and hardware aspects that can all generally be referred to herein as a “circuit,” “module” or “system.” Furthermore, aspects of the invention can take the form of a computer program product embodied in one or more computer readable medium(s) having computer readable program code embodied thereon.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general purpose computer selectively activated or configured by one or more computer programs stored in the computer memory, cache, or obtained over a network. When data is obtained over a network the data can be processed by other computers on the network, e.g. a cloud of computing resources.

The embodiments of the present invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way.

In some embodiments, any combination of one or more computer readable medium(s) can be utilized. In some embodiments, the computer readable medium can be a computer readable signal medium or a computer readable storage medium. In some embodiments, a computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

In some embodiments, a computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device.

In some embodiments, program code embodied on a computer readable medium can be transmitted using any appropriate medium, including but not limited to wireless, wire-line, optical fiber cable, RF, etc., or any suitable combination of the foregoing. In some embodiments, computer program code for carrying out operations for aspects of the invention can be written in any combination of one or more programming languages, including an object oriented programming language such as Java, Smalltalk, C++ or the like and conventional procedural programming languages, such as the “C” programming language or similar programming languages. In some embodiments, the program code can execute entirely on the user's computer, partly on the user's computer, as a stand-alone software package, partly on the user's computer and partly on a remote computer or entirely on the remote computer or server. In the latter scenario, the remote computer can be coupled to the user's computer through any type of network, including a local area network (LAN) or a wide area network (WAN), or the connection can be made to an external computer (for example, through the Internet using an Internet Service Provider).

Some embodiments of the invention are described herein with reference to flowchart illustrations and/or block diagrams of methods, apparatus (systems) and computer program products according to embodiments of the invention. It can be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In some embodiments, these computer program instructions can also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions can also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In some embodiments, the flowchart and block diagrams in the Figures illustrate the architecture, functionality, and operation of possible implementations of systems, methods and computer program products according to various embodiments of the invention. In this regard, In some embodiments, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, in some embodiments, two blocks shown in succession can, in fact, be executed substantially concurrently, or the blocks can sometimes be executed in the reverse order, depending upon the functionality involved. It can also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

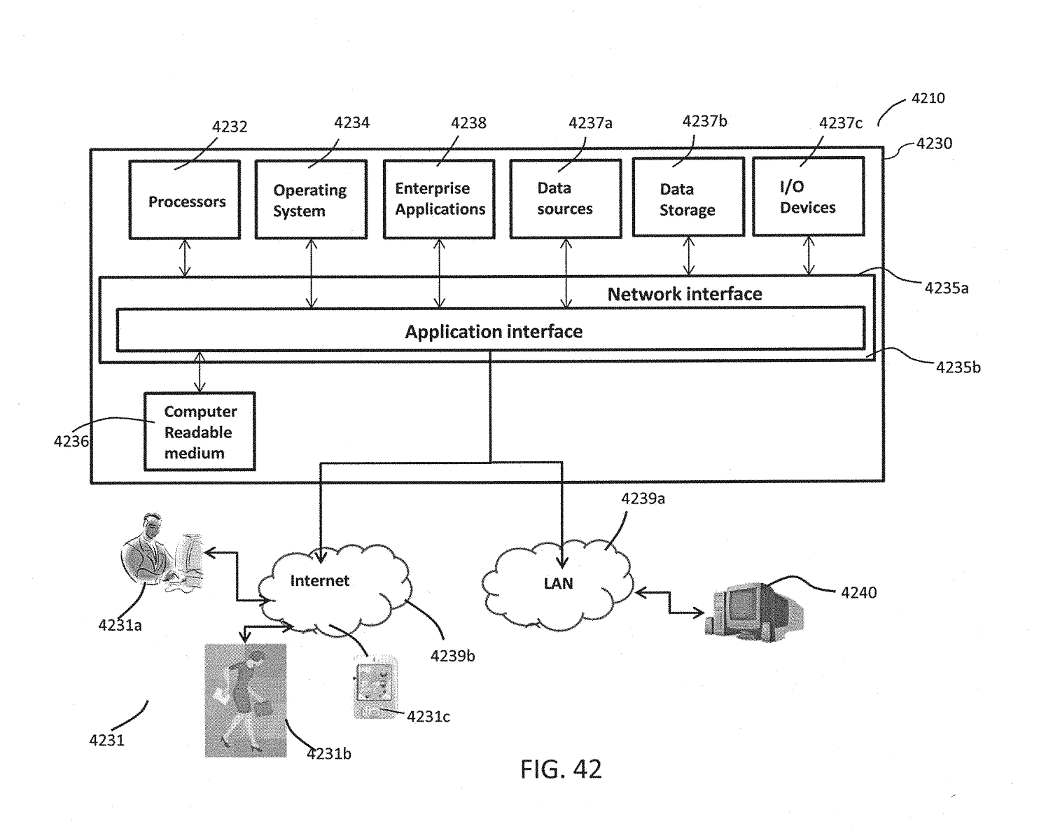

Referring to FIG. 42, the server or computing device operating a software application of the workflow management system can comprise computer system 4210, and can be configured for operating and processing components of the workflow management system and method in accordance with some embodiments of the invention. In some embodiments, the computer system 4210 can process one or more software modules of the workflow management system and method, and can be configured to display information related to workflow management within one or more graphical user interfaces. In some embodiments. the system 4210 framework can also manage the organization of data and data flow between the workflow management system and method, and external (third party) computer systems.

In some embodiments, the system 4210 can comprise one or more computing devices including at least one processor 4232. In some embodiments, the processor 4232 can include operate as one or more server platforms. In some embodiments, the system 4210 can include a network interface 4235a and an application interface 4235b coupled to the processor 4232 capable of processing at least one operating system 4234. Further, in some embodiments, the interfaces 4235a, 4235b coupled the processor 4232 can be configured to process one or more of the software modules (e.g., such as enterprise applications 4238). In some embodiments, the software modules 4238 can include server-based software that can include workflow management software modules. In some embodiments, the software modules 4238 can operate to host at least one user account and/or at least one client account, and can operate to transfer data between one or more of these accounts using the at least one processor 4232.

With the above embodiments in mind, it should be understood that the invention can employ various computer-implemented operations involving workflow management data stored in computer systems. Moreover, the above-described databases and models operating within the workflow management can store analytical models and other data on computer-readable storage media within the system 4210, as well as on computer-readable storage media coupled to the system 4210. In addition, the above-described applications of the workflow management system can be stored on computer-readable storage media within the system 4210 and on computer-readable storage media coupled to the system 4210. These operations are those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated. In some embodiments of the invention, the system 4210 can comprise at least one computer readable medium 4236 coupled to at least one data source 4237a, and/or at least one data storage device 4237b, and/or at least one input/output device 4237c.

In some embodiments, the invention can be embodied as computer readable code on a computer readable medium 4236. In some embodiments, the computer readable medium 4236 can be any data storage device that can store data, which can thereafter be read by a computer system (such as the system 4210). In some embodiments, the computer readable medium 4236 can be any physical or material medium that can be used to tangibly store the desired information or data or instructions and which can be accessed by a computer or processor 4232. In some embodiments, the computer readable medium 4236 can include hard drives, network attached storage (NAS), read-only memory, random-access memory, FLASH based memory, CD-ROMs, CD-Rs, CD-RWs, DVDs, magnetic tapes, other optical and non-optical data storage devices. In some embodiments, various other forms of computer-readable media 4236 can transmit or carry instructions to a computer 40 and/or at least one user 4231, including a router, private or public network, or other transmission device or channel, both wired and wireless. In some embodiments, the software modules 4238 can be configured to send and receive data from a database (e.g., from a computer readable medium 4236 including data sources 4237a and data storage 4237b that can comprise a database), and data can be received by the software modules 4238 from at least one other source. In some embodiments, at least one of the software modules 4238 can be configured within the system to output data to at least one user 4231 via at least one graphical user interface rendered on at least one digital display.

In some embodiments of the invention, the computer readable medium 4236 can be distributed over a conventional computer network via the network interface 4235a where the workflow management system embodied by the computer readable code can be stored and executed in a distributed fashion. For example, in some embodiments, one or more components of the system 4210 can be coupled to send and/or receive data through a local area network (“LAN”) 4239a. In some further embodiments, the networks 4239a, 4239b can include wide area networks (“WAN”), direct connections (e.g., through a universal serial bus port), or other forms of computer-readable media 4236, or any combination thereof.

In some embodiments, components of the networks 4239a, 4239b can include any number of user devices such as personal computers 40 including for example desktop computers, and/or laptop computers, or any fixed, generally non-mobile internet appliances coupled through the LAN 4239a. In some embodiments, personal computers 40 coupled through the LAN 4239a can be configured for any type of user including an administrator. In some further embodiments, one or more components of the system 4210 can be coupled to send or receive data through an internet 4239b (e.g., a wireless internet). For example, some embodiments include at least one user 4231 coupled wirelessly and accessing one or more software modules of the workflow management system including at least one enterprise application 4238 via an input and output (“I/O”) device 4237c. In some other embodiments, the system 4210 can enable at least one user 4231 to be coupled to access enterprise applications 4238 via an I/O device 4237c through LAN 4239a. In some embodiments, the user 4231 can comprise a user 4231a coupled to the system 4210 using a desktop computer, and/or laptop computers, or any fixed, generally non-mobile internet appliances coupled through the internet 4239b. In some further embodiments, the user 4231 can comprise a mobile user 4231b coupled to the system 4210. In some embodiments, the user 4231b can use any mobile computing device 4231c to wireless coupled to the system 4210, including, but not limited to, personal digital assistants, and/or cellular phones, mobile phones, or smart phones, and/or pagers, and/or digital tablets, and/or fixed or mobile internet appliances.

In some embodiments of the invention, the system 4210 can enable one or more users 4231 to couple to receive, analyze, input, modify, create and send data to and from the system 4210, including to and from one or more enterprise applications 4238 running on the system 4210. In some embodiments, at least one software application 4238 running on one or more processors 4232 can be configured to be coupled for communication over networks 4239a, 4239b through the internet 4239b. In some embodiments, one or more wired or wirelessly coupled components of the network 4239a, 4239b can include one or more resources for data storage. For example, this can include any other form of computer readable media in addition to the computer readable media 4236 for storing information, and can include any form of computer readable media for communicating information from one electronic device to another electronic device.

The embodiments and examples set forth herein were presented in order to best explain the invention and its practical application and to thereby enable those of ordinary skill in the art to make and use the invention. However, those of ordinary skill in the art can recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. An insurance workflow management system comprising:
a server having at least one processor, memory, and a non-transitory computer-readable medium in data communication with the processor;
a user terminal configurable as a geographically distributed computing network in network communication with the server, wherein the user terminal comprises a virtual/personal computer having a processor, memory, a hard disk, a video card, a display, and input/output devices; and
a software application installed on the non-transitory computer-readable medium and operated by the server, the software application including software instructions comprising the workflow management system, and wherein the server is configured to execute the software instructions to automatically direct a user through an insurance account binding process by communicating with the server using the user terminal, and
wherein the system is configured to execute the software instructions to automatically generate a document library stored on at least one of the hard drive of the server and a remote data storage, the document library including a folder structure associated with a particular account, the folder structure being automatically created by the server in response to the server executing the software instructions based on user input and a life cycle of the account, the life cycle comprising account initiation and clearance, and management from clearance through one or more intermediary steps and to invoicing the account, and
wherein the system comprises or is linked to an automated email server, the automated email server configured to email the account to a 3^{rd} party; and
wherein the software application operating on the server is configured and arranged to provide for a drag and drop feature, wherein the drag and drop feature comprises a user selecting, dragging and dropping an icon representing an electronic file, and automatically saving the file in a named folder corresponding to the electronic file; and wherein the server executing the software instructions is configured to enable the user to drag an account submission received into the email server from an insurance agency over the internet, and displayed on a GUI of the display to at least another portion of the GUI to initiate a life cycle.

2. The system of claim 1, wherein the server executing the software instructions based on user input enables the user to perform a drag and drop action from one portion of the GUI to another portion of the GUI to update or access the life cycle of the account.

3. The system of claim 1, wherein the automated email server is configured to email the account to at least one insurance market or underwriter based at least in part on user preference.

4. The system of claim 3, wherein the account submission comprises a submission from an agency for an insured looking for a specific piece of insurance coverage.

5. The system of claim 1, wherein each named folder of the workflow management system is associated with a particular step required to process and manage an account.

6. The system of claim 1, further comprising an automatic email save function, wherein emails sent through the system are automatically saved in a folder of the folder structure of the electronic library in response to executed code of the software application by the server.

7. The system of claim 1, wherein the server is configured and arranged to automatically create a copy of the dragged electronic file for the user to redact in response to dragging the electronic document and dropping it in an active window displayed on the user terminal.

8. The system of claim 1, wherein the life cycle comprises steps to process one or more accounts, the steps comprising application sections including at least one of clearance, submit to market, quote to agent, bind and invoice, endorsements, accounting, and claims.

9. The system of claim 8, wherein the steps comprise a specific sequence of steps of clearance, followed by submit to market, followed by quote to agent, followed by bind and invoice, followed by endorsements, followed by accounting, and followed by claims.

10. The system of claim 1, wherein the software application operating on the server is configured and arranged to enable a user to access or enter specific information for one or more accounts including at least one of loss information history and claim information for a specific submission, underwriting information, one or more carriers information, premium and deductibles, and quote information.

11. The system of claim 1, wherein the software application operating on the server is configured and arranged to enable a user to generate taxes on an account and use rating tools to underwrite an account.

12. The system of claim 1, wherein the server executing the software instructions based on user input is configured to enable the user to drag into the GUI claim adjuster information sent from a carrier assigned to an insurance claim.

13. The system of claim 1, wherein the server executing the software instructions based on user input is configured to enable the user to send insurance adjuster information to an agent.

14. The system of claim 1, wherein the software application includes executable code to enable the server to display a dashboard including widgets to show in real-time or substantially real-time at least one of retail agencies revenues, carriers premiums, month to date results, year to date results, producer monthly projections, marketing calendar, pipeline, overdue receivables and suspense, and account reconciliation.

15. A workflow management system comprising:
a server having a processor, memory, and a non-transitory computer-readable medium in data communication with the processor;
a user terminal configurable as a geographically distributed computing network in network communication with the server, wherein the user terminal comprises a virtual/personal computer having a processor, memory, a hard disk, a video card, a display, and input/output devices; and a software application installed on the non-transitory computer-readable medium and operated by the server, the software application including software instructions comprising the workflow management system, and wherein the server is configured to execute the software instructions to automatically direct a user through an insurance account binding process by communicating with the server using the user terminal, and
wherein the software application operating on the server is configured and arranged to provide for a drag and drop feature, wherein the drag and drop feature comprises a user selecting, dragging and dropping an icon representing an electronic file, and automatically saving the file in a named folder corresponding to the electronic file, the folder structure being automatically created by the server in response to the server executing the software instructions based on user input in one or more steps of a life cycle of the account, and wherein
the steps comprise application sections including at least one of clearance, submit to market, quote to agent, bind and invoice, endorsements, accounting, and claims.

16. The system of claim 15, wherein the system comprises or is linked to an automated email server, the automated email server configured to email the account to at least one insurance market or underwriter based at least in part on user preference.

17. The system of claim 15, wherein each named folder of the workflow management system is associated with a particular step required to process and manage an account.

18. The system of claim 15, wherein the life cycle comprises account initiation and clearance, and management from clearance through one or more intermediary steps and to invoicing the account.

19. The system of claim 15, further comprising an automatic email save function, wherein emails sent through the system are automatically saved in a folder of the folder structure of the electronic library in response to executed code of the software application by the computing device.

20. The system of claim 15, wherein the software application operating on the server is configured and arranged to create a copy of the dragged electronic document for the user to redact in response to dragging the electronic document and dropping it in an active window of the GUI.
